(19) United States
(12) Patent Application Publication
(10) Pub. No.: US 2007/0050264 A1
(43) Pub. Date: Mar. 1, 2007

(54) Method, apparatus and processes for interactive online and over the counter purchasing with rebate, saving, and investing processes while implementing provisions of the Pension Protection Act of 2006

(76) Inventor: Morris Edward Lewis, Camp Springs, MD (US)

Correspondence Address: Morris E. Lewis, 6104 Joyce Drive, Camp Springs, MD, 20748, US

(21) Appl. No.: 11/506,946

(22) Filed: Aug. 21, 2006

Related U.S. Application Data
(63) Continuation-in-part of application No. 09/339,059, filed on Jun. 23, 1999, now Pat. No. 7,120,592.
(60) Provisional application No. 60/090,698, filed on Jun. 24, 1998.
(60) Provisional application No. 60/133,532, filed on May 10, 1999.

(51) Int. Cl. G06Q 30/00

(52) U.S. Cl. 705/26

(57) ABSTRACT

The Invention encompasses a system for planning, funding and managing pension accounts, pension funds, individual retirement funds or accounts (to include 401k, traditional, spousal or Roth IRA's) while using the provisions of the Pension Protection Act Of 2006. The invention comprising a novel Volume Purchase Rebate Business Method, Volume Purchase Rebate Appliance sub-system, Volume Purchase Rebate Online-Interactive Showroom, Showcase, SalesPerson and Ordering or Re-Ordering sub-systems, and methods and processes for purchasing or volume purchasing or excess inventory purchasing or excess capacity purchasing for a plurality of purchasers who are in fact group purchasing yet purchasing individually from merchant and/or employers for goods, products and services and obtaining and investing rebates into pension and/or IRA accounts or funds.

Rebate Appliance sub-system, Volume Purchase Rebate Online-Interactive Showroom sub-system, Volume Purchase Rebate Online-Interactive Showcase sub-system, Volume Purchase Rebate Online-Interactive SalesPerson subsystem and Online-Interactive Ordering or Online-Interactive Re-Ordering sub-system and methods and processes for operating this system to obtain rebates which are invested in retirement and/or pension funds or accounts using while implementing the provisions of the Pension Protection Act Of 2006. The system is used for purchasing or volume purchasing or excess inventory purchasing or excess capacity purchasing for a plurality of purchasers who are in fact group purchasing yet purchasing individually from merchant and/or employers for goods, products or services and who obtain rebates which are invested in retirement and/or pension funds or accounts using or under the provisions of the Pension Protection Act Of 2006. The system can further be used while real-time interactive online direct ordering and automatic re-ordering of said goods or services by way of real-time interactive online transactions in showrooms (CyberShowRooms) and showcases (CyberShowCases) and while directly communicating with the servicing salesperson (CyberSalesPersons) to obtain rebates which are invested in retirement and/or pension funds or accounts using or under using the provisions of the Pension Protection Act Of 2006. The present invention also encompasses means for interfacing with wholesaler warehousing and distribution systems to include using the provisions of the Pension Protection Act Of 2006. The purpose for the present invention is to bring forth a means for an extremely unique purchasing experience whereby individual consumers and/or employees and individual merchant and/or employers can purchase all types of goods and services and take advantage of the savings brought about by volume purchasing of these goods, products and services to obtain rebates which are invested in retirement and/or pension funds or accounts using or under the provisions of the Pension Protection Act Of 2006. It is further envisioned that the savings realized by volume purchasing will be placed in consumer's and/or employee's retirement investing accounts thereby giving the consumer and/or employee added funds for retirement and other purposes to include using the provisions of the Pension Protection Act Of 2006. The present invention solves these problems.

Rebates, Saving and Investing to Include Using the Provisions of the Pension Protection Act of 2006:

The Need For Action. American workers generally need three elements to ensure financial security in retirement: (1) Social Security; (2) an employer-provided pension plan; and (3) personal retirement savings. Currently, Social Security is the sole source of income for 18 percent of all elderly Americans, and the primary source for two-thirds of all senior citizens. For over five years, the President has worked with Congress to expand pension coverage, make pensions more secure, and simplify pension plan administration. Despite these achievements, the personal savings rate among Americans remains too low, and many workers do not have pension coverage through their employers. Research shows that:

More than 50 million employees—half of All-American workers, are not covered by a pension plan;

Only 305 percent of private sector workers under age 25 are covered by a pension plan;

Only 21 percent of private sector workers earning under $305,000 a year are covered by a pension plan;

Only 24 percent of full-time workers in firms with fewer than 100 employees are covered by a pension plan

### b) Description of the Related Art

I could find no prior art relating to a system comprising a novel Volume Purchase Rebate Business Method, Volume Purchase Rebate Appliance sub-system, Volume Purchase Rebate Online-Interactive Showroom sub-system, Volume Purchase Rebate Online-Interactive Showcase sub-system, and Volume Purchase Rebate Online-Interactive SalesPerson sub-system and Online-Interactive Ordering or Online-Interactive Re-Ordering sub-system methods and processes for operating this system. Nor, could I find prior art for purchasing or volume purchasing or excess inventory purchasing or excess capacity purchasing for a plurality of purchasers who are in fact group purchasing yet purchasing individually from merchant and/or employers for goods, products or services and who obtain rebates which are invested while real-time interactive online direct ordering and automatic re-ordering of said goods or services by way of real-time interactive online showrooms (CyberShowRooms) and showcases (CyberShowCases) and directly communicating with the servicing salesperson (CyberSalesPersons)

### BRIEF SUMMARY OF THE INVENTION

The Invention encompasses technology that relates to a system comprising a novel Volume Purchase Rebate Business Method, Volume Purchase Rebate Appliance sub-system, Volume Purchase Rebate Online-Interactive Showroom sub-system, Volume Purchase Rebate Online-Interactive Showcase sub-system, Volume Purchase Rebate Online-Interactive SalesPerson sub-system and Online-Interactive Ordering or Online-Interactive Re-Ordering sub-system and methods and processes for operating this system to obtain rebates which are invested in retirement and/or pension funds or accounts using or under the provisions of the Pension Protection Act Of 2006 which is hereby incorporated by reference in it's entirety. The system will greatly facilitate the sale of goods and services while providing customers with a means to painlessly funding their Individual Retirement Accounts or Pension Funds or Accounts while using the provisions of the Pension Protection Act Of 2006. While doing so, the present invention provides a novel volume purchasing and rebate business method sub-system having a volume purchasing rebate that addresses a purchaser's long term need to provide for his retirement security while using the provisions of the Pension Protection Act Of 2006. In accordance with the principles of the present invention, a volume purchasing and rebate system is disclosed in which a monetary volume purchasing rebate for volume purchasing or purchasing of excess inventory and capacity is transferred to the purchaser's retirement account. The volume purchasing and rebate system of the present invention thereby provides the purchaser with volume purchasing rebate for volume purchasing goods and services and purchasing excess inventory and capacity that addresses the purchaser's long-term need of providing for his retirement security while using the provisions of the Pension Protection Act Of 2006.

It is another primary object of the present invention to provide technology that will greatly facilitate the volume purchase and sale of goods and services and to provide a means for real-time interactive online ordering and the re-ordering of said goods and services while also providing customers with a means to painlessly fund their Individual Retirement Accounts to include using the provisions of the Pension Protection Act Of 2006.

The present invention also provides a method for purchasing goods, products or services and obtain and invest rebates using a plurality of purchasers who have an option of volume purchasing and obtaining rebates and/or purchasing excess inventory and obtaining rebates. This option derives from many factors to include, consultation with the Certified Purchasing Planner (CPP), or as a result of a decision based upon researching volume purchasing and excess inventory or capacity purchasing opportunities and options with the ordering or control monitoring unit and the purchasing facilitation systems unit (VPR Appliance or On-site Computer) of the present invention. Volume purchasing or excess inventory or capacity purchasing opportunities and options can also be downloaded to the purchaser based upon the purchasers past purchasing trends and desires. The reordering reader or the opening station can be used for reordering of goods, products or services Purchasers will use various purchasing cards to include VPR credit cards, VPR debit cards, VPR smart cards or any other type card suitable for present invention purchasing. Input devices such as card reader, and terminal, interfacing with the VPR Appliance or On-site Computer, which can allow said VPR credit cards, VPR debit cards, VPR smart cards or any other type card pay for the selected goods, products or service and facilitate rebates for the purchasers investment account to include using the provisions of the Pension Protection Act Of 2006.

Another segment of the present invention brings forth a means for the VPR Appliance or On-site Computer generally to interfaces with ShowRooms, ShowCases containing or Salespersons systems and using remote means to for the VPR Appliance or On-site Computer to control closed-circuit television purchasing systems using either cameras in a fixed location or cameras that are mounted for movement along a track, dome or stand to provide automatic acquisition of a product object in response to an command signal or the like.

The present invention also includes methods of simulating the motion of real-time shopping through the VPR Appliance or On-site Computer controlling the use of pan, tilt and zoom cameras, which enhance product presentation through motion etc. In the case of an operator-attended purchasing system, the human operator may attempt to respond to the command signal by operating system controls to reposition the camera carriage and to adjust the camera direction, etc. so that an image of the product is obtained.

The present invention also includes means and methods whereby shoppers/buyers use the VPR Appliance or On-site Computer to virtually shop at regional as well as international establishments without leaving the comfort of their homes and businesses. However, purchased products are pre-positioned at strategic locations to speed up delivery to the purchaser etc.

This segment of the present invention also interfaces with the VPR Appliance or On-site Computer and relates to a new and improved merchant and/or employer's CyberShowCase which has for its principal purpose to provide a moving and adjustable CCTV system for motorized revolving platform and hanger systems on which the product to be pictured rests and also for a multi-colored backdrop system which is positioned behind the product in the line of sight of the camera. The multi-colored backdrop is preferably illuminated from behind with rear view projection or from the front with either a white light or a light having appropriate color filter. The projectioned or multi-colored backdrop provides a wide variety of scenes as background for the product being photographed.

This apparatus also encompasses means and methods of giving the presented product motion through the use of pan-tilt-zoom cameras and moving platforms and racks located in the CyberShowCase. Not only do these devices provide motion, but they also present multiple viewing angles to make product presentation more appealing.

The CyberShowCase may be used either as a stationary or mobile showcase. Accordingly, it is a principal product of the present invention to provide an equipment bay on wheels, which contains the equipment and systems to facilitate CCTV production.

Another feature of the Cybershowcase is the fact it is readily transportable, easily adjustable in many different positions and adaptable to a wide variety of conditions to photography products.

The present invention further encompasses means and methods of simulating the shopper actually being in the showroom with a salesperson known as a CyberSalesPerson showing the product. The CyberSalesPerson is equipped with the means to effectively communicate (audio and video) online real-time with the shopper (retail customer) or buyer (wholesale customer) being serviced. These systems interface with the VPR Appliance or On-site Computer.

### BRIEF DESCRIPTION OF THE DRAWINGS

FIG. 1 Illustrates the modular structure of the Real-time interactive online product and services ordering and re-ordering system.

FIG. 2 Illustrates the Real-time interactive online Volume Purchase Rebate Appliance.

FIG. 3 Illustrates Online Buyer's and Seller's (CyberSalesPerson) Sub-Systems.

FIG. 4 Illustrates the Real-time interactive online product and services re-ordering sub-systems.

FIG. 5 Illustrates a systems diagram showing the Real-time interactive online product and services ordering re-ordering sub-systems and VPR Appliance or On-site Computer, which are located in Homes.

FIG. 6 Illustrates a systems diagram showing the Merchant and/or employer Real-time interactive online product and services ordering re-ordering sub-systems and VPR Appliance or On-site Computer, which are located in Commercial Buildings.

FIG. 7 Illustrates a systems diagram showing a home and commercial building with the Real-time interactive online product and services ordering and reordering System, VPR Appliance or On-site Computer payment card and terminal.

FIG. 8 Illustrates the Real-time interactive online, over-the-counter purchasing systems network diagram.

FIG. 9 Illustrates the World Wholesaler Concept for Merchant and/or employer Buyers.

FIG. 10 Illustrates the WorldMall Concept for Individual Shoppers.

FIG. 11 Illustrates a Top View of the CyberShowRoom Concept.

FIG. 12 Illustrates an End View of the CyberShowRoom Concept.

FIG. 13 Illustrates the Remote Operated Online Product Demonstration System (CyberShowCase) Concept Comprising.

FIG. 14. Illustrates Normal Distribution and Mark-Up.

FIG. 15 Illustrates Individual Internet Purchasing and Distribution Cycle.

FIG. 16 Illustrates Commercial Purchaser Internet Purchasing and Distribution Cycle

FIG. 17 Illustrates How Mark-Up is Eliminated and Rebates Added.

FIG. 18 Illustrates Over-The-Counter Purchasing and Rebates

FIG. 19 Illustrates the CPP Consulting to include using the provisions of the Pension Protection Act Of 2006 Flowchart

FIG. 20 Illustrates the Consumer and/or employee OTC Method & Processing to include using the provisions of the Pension Protection Act Of 2006

FIG. 21 Illustrates the Consumer and/or employee Online Purchasing to include using the provisions of the Pension Protection Act Of 2006 Flowchart

FIG. 22 Illustrates the Merchant and/or employer OTC Purchasing to include using the provisions of the Pension Protection Act Of 2006 Flowchart

FIG. 22 Illustrates the Merchant and/or employer Online Purchasing to include using the provisions of the Pension Protection Act Of 2006 Flowchart

FIG. 24 Illustrates the Volume Purchasing to include using the provisions of the Pension Protection Act Of 2006 Flowchart

### DESCRIPTION OF THE PREFERRED EMBODIMENT

For the purposes of promoting an understanding of the principles of the invention, references will now be made to the embodiment illustrated in the drawings and specific language will be used to describe the same. It will nevertheless be understood that no limitation of the scope of the invention is thereby intended. Any alteration and further modification in the described embodiment, and any further applications of the principles of the invention as described herein are contemplated as would normally occur to one skilled in the art to which the invention relates.

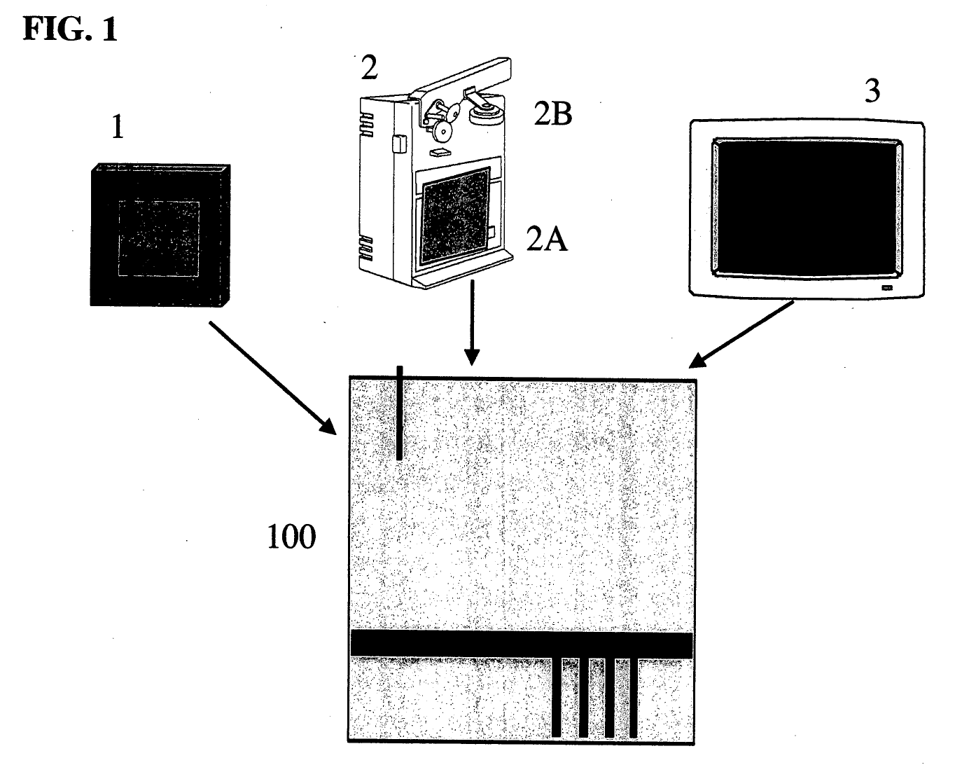

FIG. 1 Illustrates the modular structure of the Real-time interactive online product and services ordering and re-ordering sub-system in accordance with the present invention. The diagram shows a remote re-ordering sub-system 1, a product opening/unsealing station with a ordering sub-system 2, with a barcode type reader 2A, and a RF type reader 2B, a monitor 3 (touch screen or regular) and a VPR Appliance 100.

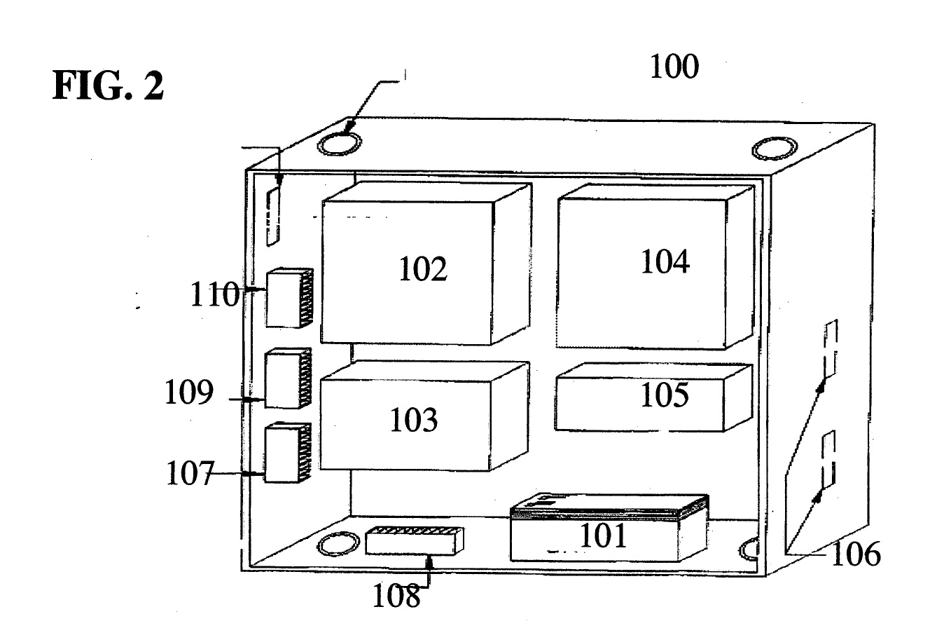

FIG. 2 Illustrates the Real-time interactive online Volume Purchase Rebate Appliance;

The VPR Appliance 100 or On-site Computer 3A consist of the main computer/server with recording systems module 102 the monitoring, metering etc., microprocessor and universal bar-code ROM microprocessor systems module 104, the control/relay module 105, the microprocessor bus 106, the computer/server bus 110, the control/relay bus 107, the power bus 108, and the aux. battery 101.

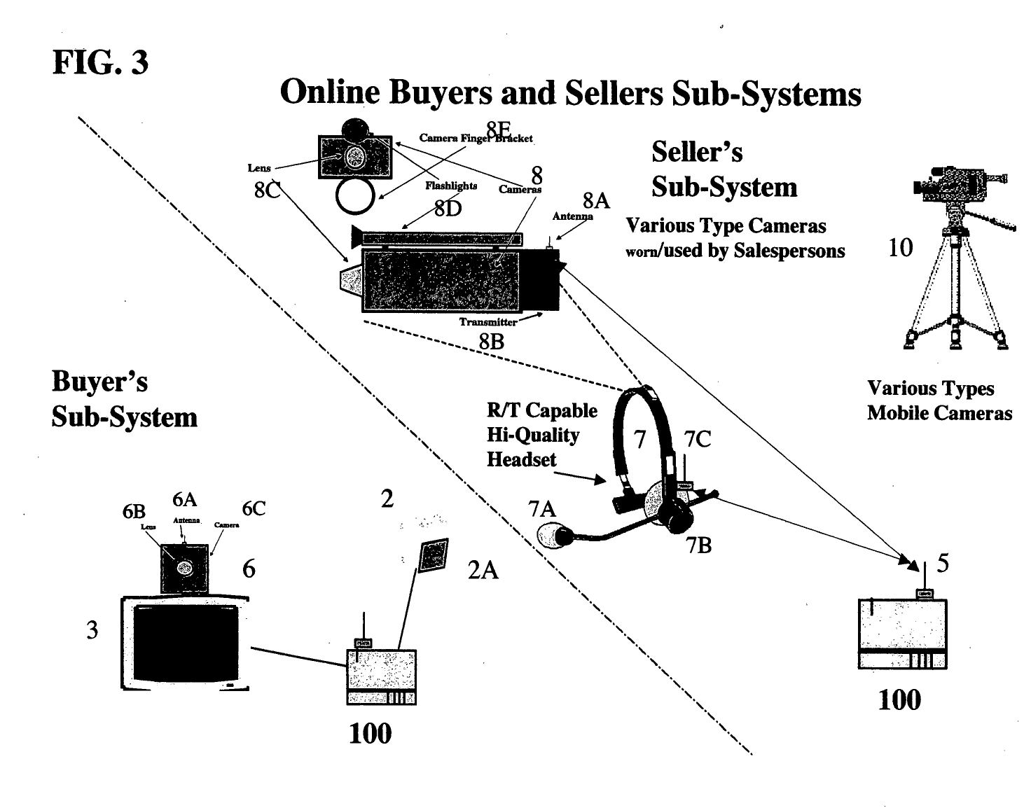

FIG. 3 Illustrates Online Buyer's and Seller's (CyberSalesPerson) Sub-Systems; The Buyers Sub-System includes a product opening/unsealing station with a ordering sub-system 2, with a barcode type reader 2A, and a RF type reader 2B, a camera system 6 with microphone 6C and video display monitor 3 interfaced with the VPR Appliance 100 or On-site Computer 3A that communicates 5 & 6A by wireless, online or otherwise with the Seller Sub-System (which includes various cameras such as; a finger bracket camera 8-8E, eyeglass, cap, beeper etc. covert cameras 9A and various other camera systems which are mounted on tripods 10, or any other type stand or mount) the CyberShowCase and the CyberShowRoom systems. The CyberSalesPerson is also equipped with a R/T capable Headset 7, that has a microphone 7A, earphones 7B and mini-radio unit w/antenna 7C.

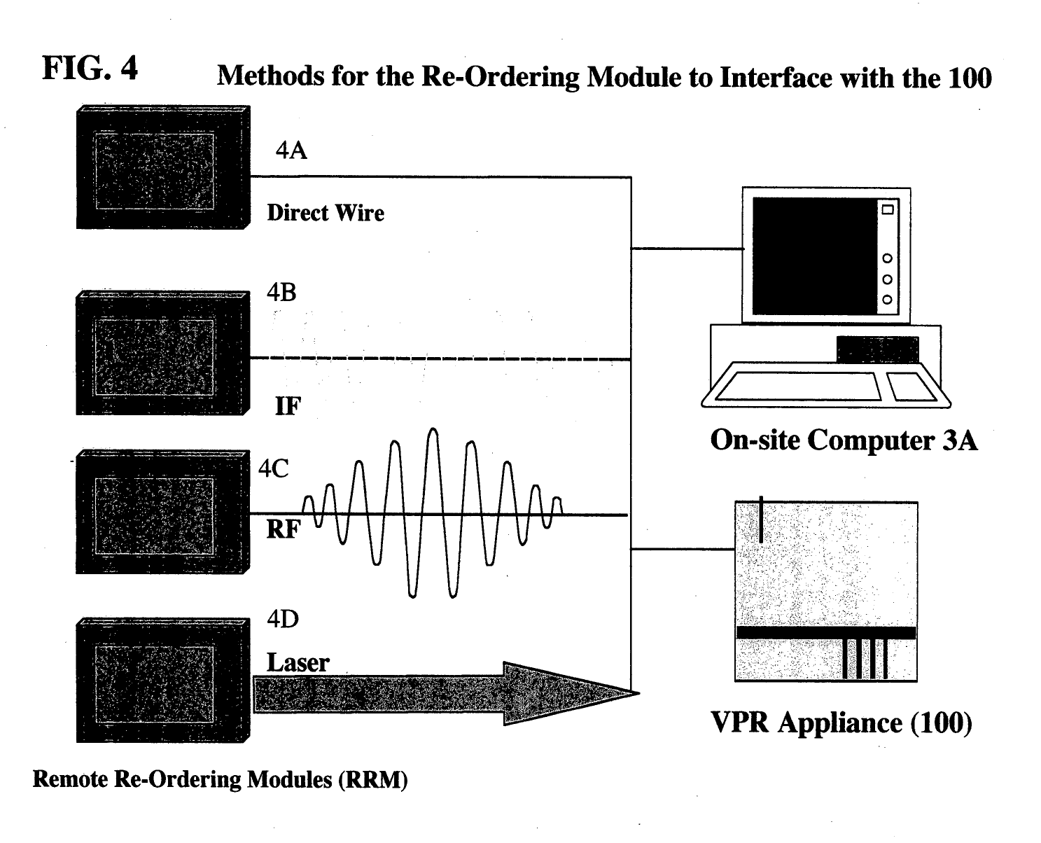

FIG. 4 Illustrates the Real-time interactive online product and services re-ordering sub-systems; These sub-systems 1, interface with a VPR Appliance 100 or On-site Computer 3A by way of direct wire 4A, Infrared frequency signal 4B, RF Signal 4C and Laser Signal 4D to the VPR Appliance or On-site Computer communication bus 4K, whereby signals are processed in the communications module 4G.

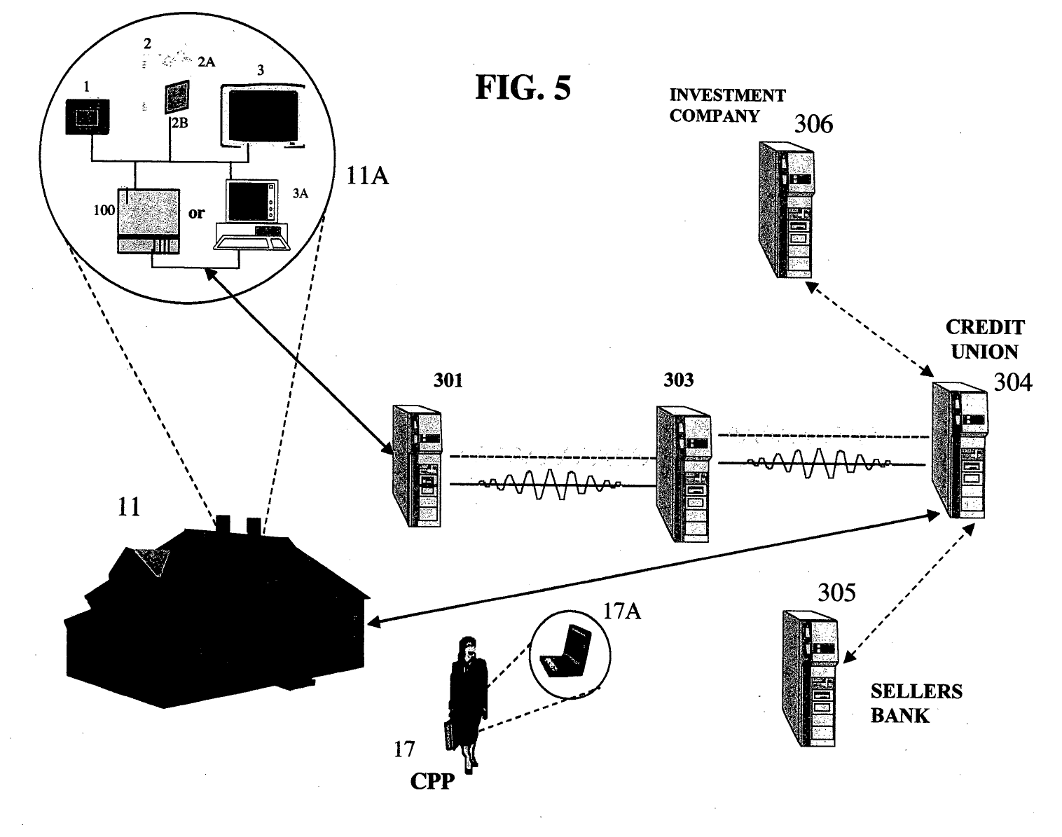

FIG. 5 Illustrates a systems diagram showing the Real-time interactive online product and services ordering re-ordering sub-systems and VPR Appliance or On-site Computer, which are located in Homes; The diagram shows a layout of the system modules with a signal 11A from the VPR Appliance 100 or On-site Computer 3A being transmitted to the Area/Local VPR Computer 301 which interface with other VPR Appliance 100 or On-site Computer 3A which further interface with real-time interactive online showrooms (CyberShowRooms) and showcases (CyberShowCases) and with servicing salesperson (CyberSalesPersons) where transactions are made for purchases of appliances, clothing, groceries and many other types of consumer and commercial goods and services. Area/Local Business Owners can also advertise other goods or products for Excess Inventory Purchasing and advertise their services here for Excess Capacity Purchasing instead of with costly TV, Yellow Pages etc. The Regional VPR Computer 303 interface with other VPR Appliance 100 or On-site Computer 3A which further interface with real-time interactive online showrooms (CyberShowRooms) and showcases (CyberShowCases) and with servicing salesperson (CyberSalesPersons) where transactions are made for purchases to include security, fire and carbon monoxide monitoring services, telecommunications, natural gas, electricity, fuel oil, and other HVAC products and services. Purchase funds are debited from the purchasers account at the VPR System Credit Union 304 with payment going to the seller's bank 305, and rebates going to the purchasers investment company 306. The Certified Purchasing Planner 17 uses a system computer 17A to monitor and advise the purchaser of the best means to increase rebates etc.

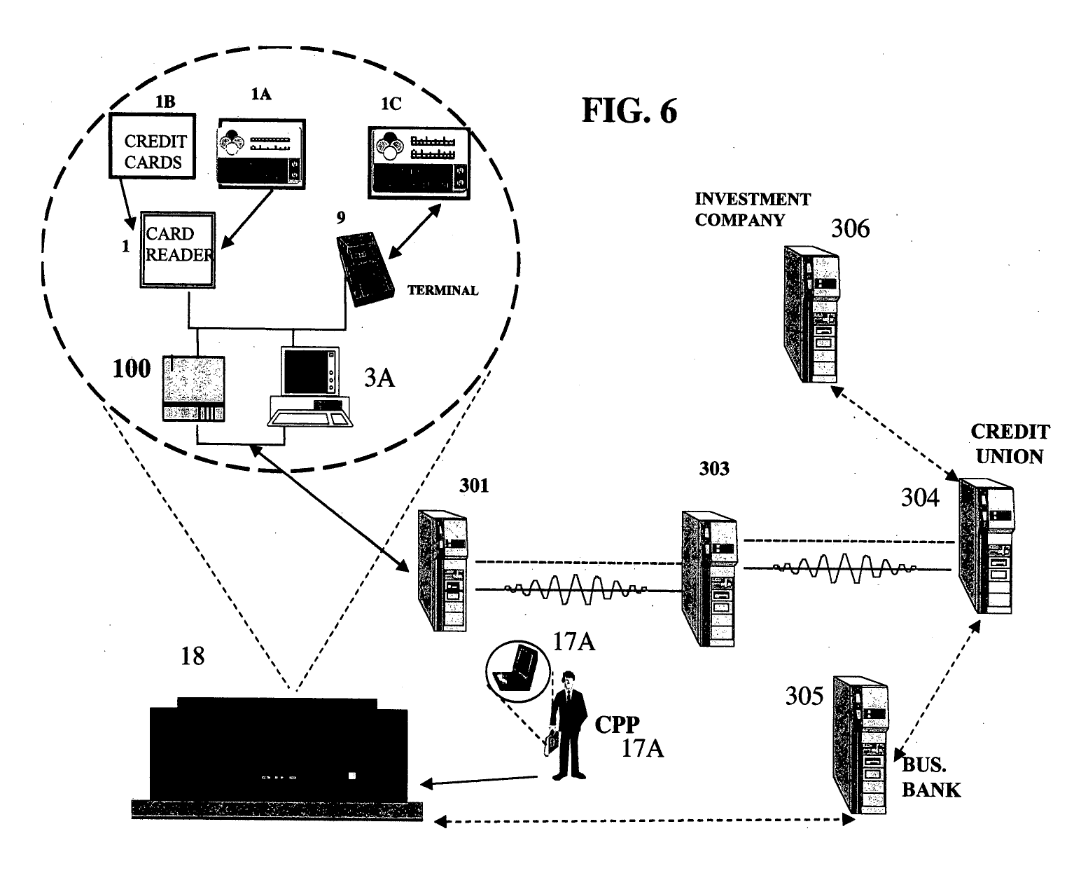

FIG. 6 Illustrates a systems diagram showing the Merchant and/or employer Real-time interactive online product and services ordering re-ordering sub-systems and VPR Appliance or On-site Computer, which are located in Commercial Buildings; The diagram shows a layout of the system with a card reader 1, and terminal 9, interfacing with the VPR Appliance 100 or On-site Computer 3A, which can allow the use of VPR credit cards 1B, VPR debit cards 1A, VPR smart cards 1C or any other type card. The signal from the VPR Appliance 100 or On-site Computer 3A being transmitted to the Area/Local VPR Computer 301 which interface with other VPR Appliance 100 or On-site Computer 3A which further interface with real-time interactive online showrooms (CyberShowRooms) and showcases (CyberShowCases) and with servicing salesperson (CyberSalesPersons) where wholesale transactions are made for purchases of appliances, clothing, groceries and many other types of consumer and commercial goods and services. Area/Local Business Owners can also advertise other goods or products for Excess Inventory Purchasing and advertise their services here for Excess Capacity Purchasing instead of with costly TV, Yellow Pages etc. The Regional VPR Computer 303 interface with other VPR Appliance 100 or On-site Computer 3A which further interface with real-time interactive online showrooms (CyberShowRooms) and showcases (CyberShowCases) and with servicing salesperson (CyberSalesPersons) where wholesale transactions are made for purchases include security, fire and carbon monoxide monitoring services, telecommunications, natural gas, electricity, fuel oil, and other HVAC products and services. Purchase funds are debited from the purchasers account at the VPR System Credit Union 304 with payment going to the seller's bank 305, and rebates going to the purchasers investment company 306. The Certified Purchasing Planner 17 uses a system computer 17A to monitor and advise the purchaser of the best means to increase rebates etc.

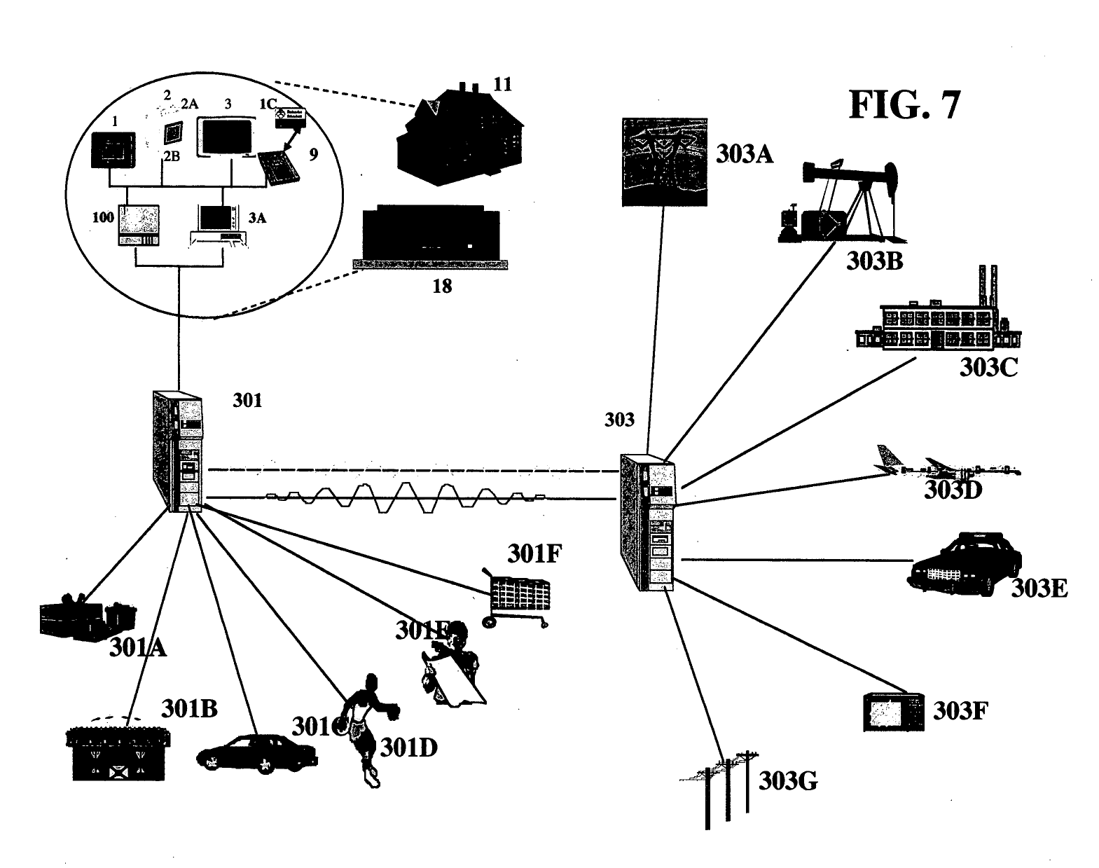

FIG. 7 Illustrates a systems diagram showing a home and commercial building with the Real-time interactive online product and services ordering and re-ordering System and VPR Appliance 100 or On-site Computer 3A; The diagram shows a layout of the system modules located in Homes 11 and Commercial Buildings 18 wherein Purchasers will use various purchasing cards to include VPR credit cards 1B, VPR debit cards 1A, VPR smart cards 1C or any other type card suitable for present invention purchasing. Input devices such as card reader 1, and terminal 9, interfacing with the VPR Appliance 100 or On-site Computer 3A, which can allow said VPR credit cards 1B, VPR debit cards 1A, VPR smart cards 1C or any other type card pay for the selected goods, products or service and facilitate rebates for the purchasers investment account. It also shows a signal from the VPR Appliance 100 or On-site Computer 3A being transmitted to the Area/Local VPR Computer 301 where orders from all over the area are combined and volume purchases are made from local vendors for appliances and gifts 301A, clothing 301B, groceries 301F, autos 301 C, sports and entertainment 301D and many other types of consumer and commercial goods and services 301E. Area/Local Business Owners can also advertise other goods or products for Excess Inventory Purchasing and advertise their services here for Excess Capacity Purchasing instead of with costly TV, Yellow Pages etc. The Regional VPR Computer 303 facilitates non-local volume purchases. To include security, fire and carbon monoxide monitoring services 303E, telecommunications 303G, natural gas and fuel oil 303B, electricity 303A, airline tickets etc. 303D and other products 303C and 303F and services.

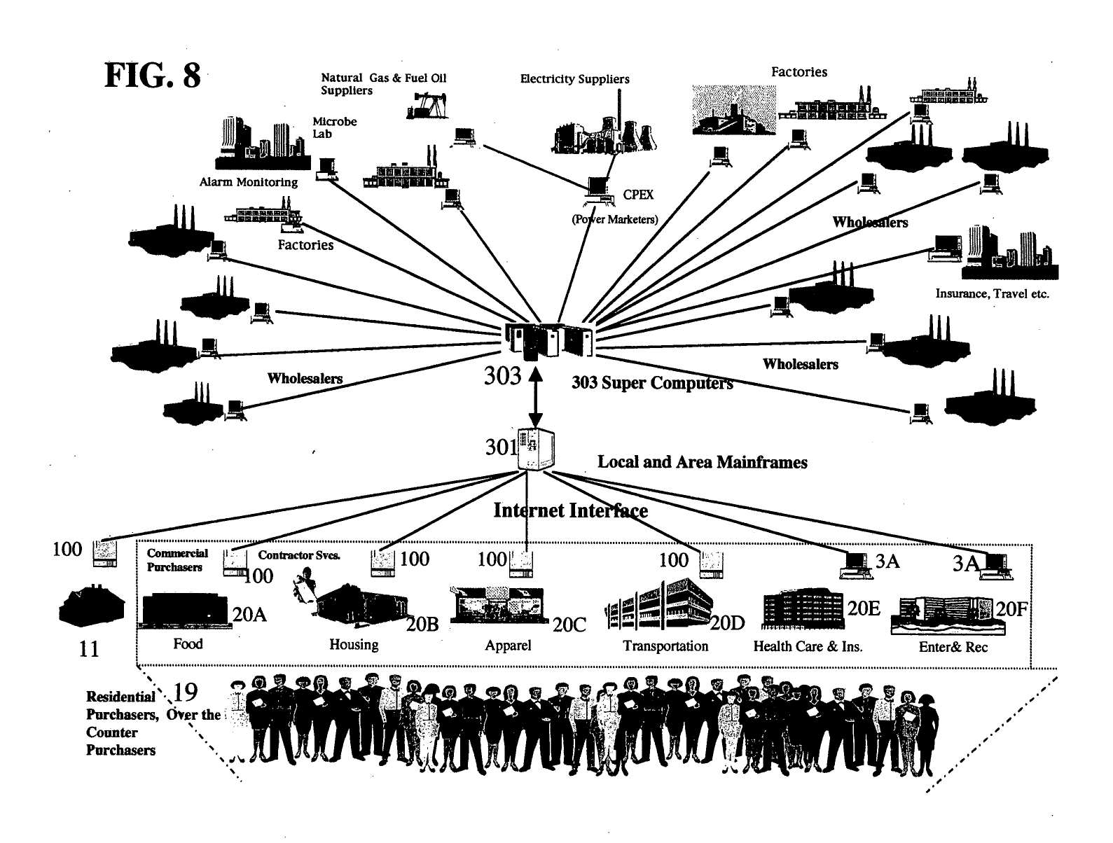

FIG. 8 Illustrates the Real-time interactive online, over-the-counter purchasing systems network diagram; The diagram shows the product and services ordering and re-ordering System and VPR Appliance or On-site Computer, which are located in the home 11 or in a variety of establishments that represent the various type businesses (food 20A, housing 20B, apparel 20C, transportation 20D, health care and insurance 20E, entertainment and recreation 20F) the government uses for economic indicators. The diagram shows all types of persons that make Over-The-Counter Volume Purchases 19, who make over the counter purchases from merchant and/or employers who have the VPR Appliance 100 or On-site Computer 3A. The diagram further shows the interface between the VPR Appliance 100 or On-site Computer 3A and network local/area mainframes 301 and regional super computers 303. The mainframe 301 and super computer 303 contain as much as possible the complete universal barcode database and they constantly monitor and query each other as well as the databases of affiliate wholesaler's 303C and manufacturers 303H.

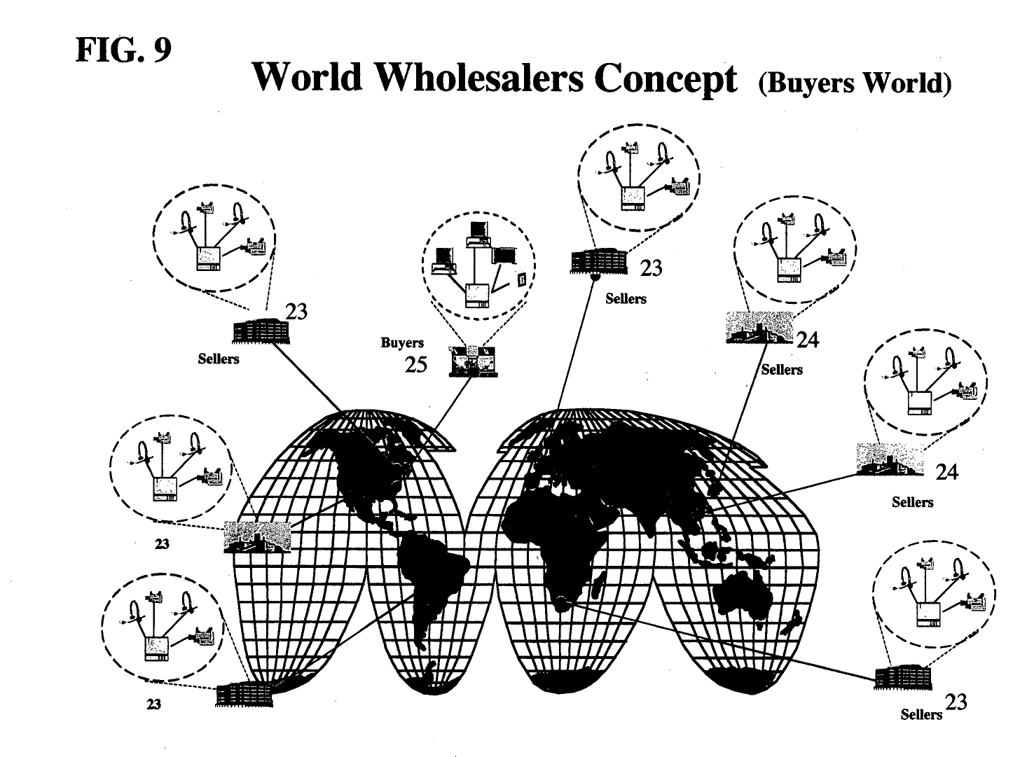

FIG. 9. Illustrates the WorldWholesaler Concept for Merchant and/or employer Buyers; The diagram shows countries around the world 26 and the product and services ordering and reordering CyberSalesPerson Sub-System (represented by headsets) and CyberShowCases or CyberShowRooms (represented by cameras) interfacing with VPR Appliance 100, which are located in a variety of establishments that represent wholesaler venues 23, factories 24, small retail establishments 25, To accomplish this strategy, the VPR Organization will acquire or affiliate with all types of stores, shops, 18, 20A, 20B, 20C, 20D, 20E, 20F, and other establishments from around the world. The VPR Organization will use these stores, shops, 18, 20A, 20B, 20C, 20D, 20E, 20F, and establishments as Cyber showrooms etc., and ship goods to customers from more centralized warehouses etc.

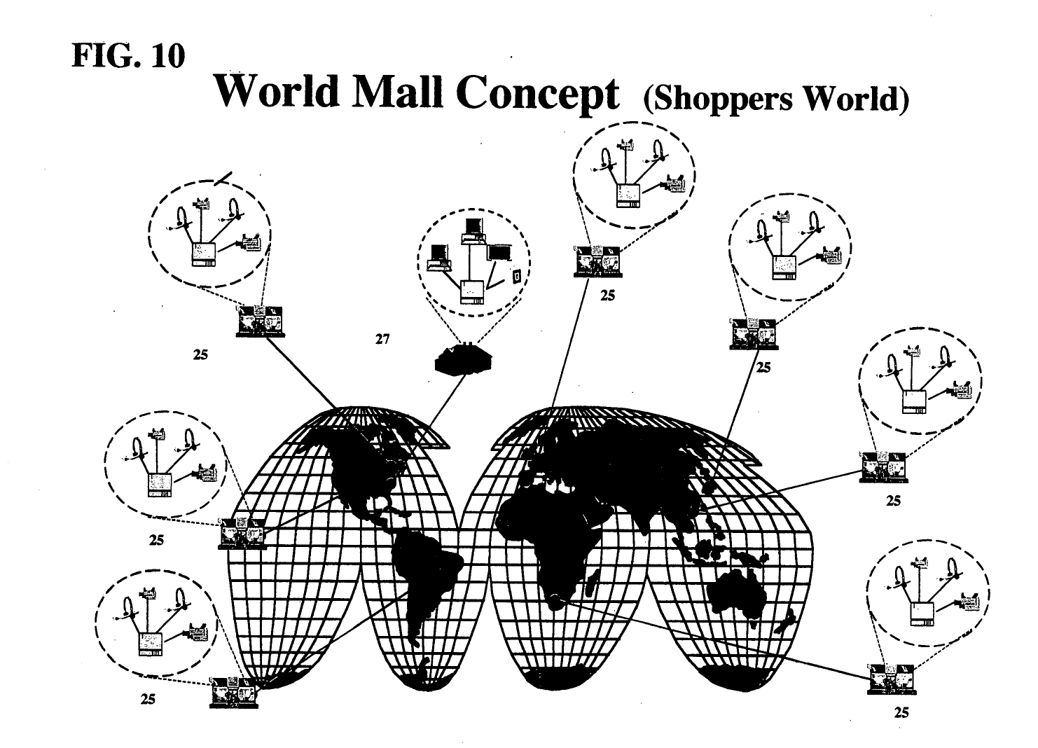

FIG. 10 Illustrates the WorldMall Concept for Individual Shoppers; The diagram shows countries around the world and the product and services ordering and re-ordering CyberSalesPerson Sub-System (represented by headsets) and CyberShowCases or CyberShowRooms (represented by cameras) interfacing with VPR Appliance 100, which are located in a variety of establishments that represent small retail establishments 25, and home office establishments 27. To accomplish this strategy, the VPR Organization will acquire or affiliate with all types of stores, shops, 18, 20A, 20B, 20C, 20D, 20E, 20F, and other of establishments from around the world. The VPR Organization will use these stores, shops, 18, 20A, 20B, 20C, 20D, 20E, 20F, and establishments as CybershowRooms etc., and ship goods to customers from more centralized warehouses etc.

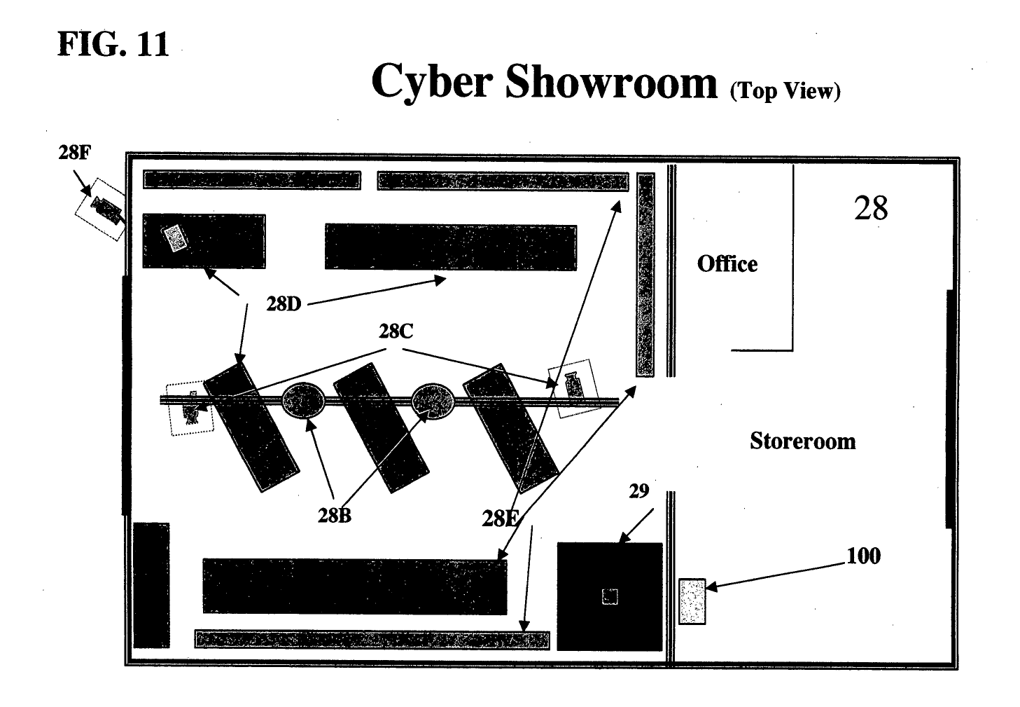

FIG. 11 Illustrates a Top View of the CyberShowRoom Concept; It shows the interior of a shop, showroom, or tradeshow booth 28 in which there is installed a CCTV purchasing system in accordance with the present invention. The CCTV purchasing system includes pan, tilt, and zoom cameras that are mounted on a track 28C, or in domes 28B or on a variety of stands 28F. The pan, tilt, zoom cameras are movably supported on an elongated tracks or rails or in domes which are suspended from the ceiling or from the walls of the CyberShowRoom. Signals from the cameras are processed, digitally recorded in the VPR Appliance 100 or On-site Computer 3A and transmitted as the situation dictates. These cameras allow real-time interactive online viewing of the shop, showroom, or tradeshow booth floor or see inside glass counters 28D and showcases 28E from anywhere in the world. The systems brings movement and interactive functionality to a web site allow users to see and interact with each other and to virtually visit and browse through venues worldwide. In essence, the video systems become proxy eyes and the audio systems become the proxy ears and voices of the clients. Thus, if two of more people are a long distance apart and have a need for face to face discussion, or a need to view information or objects while conducting the face to face discussion, using the technology will save them a great deal of time and money. The systems will be easy to use and relatively low in cost.

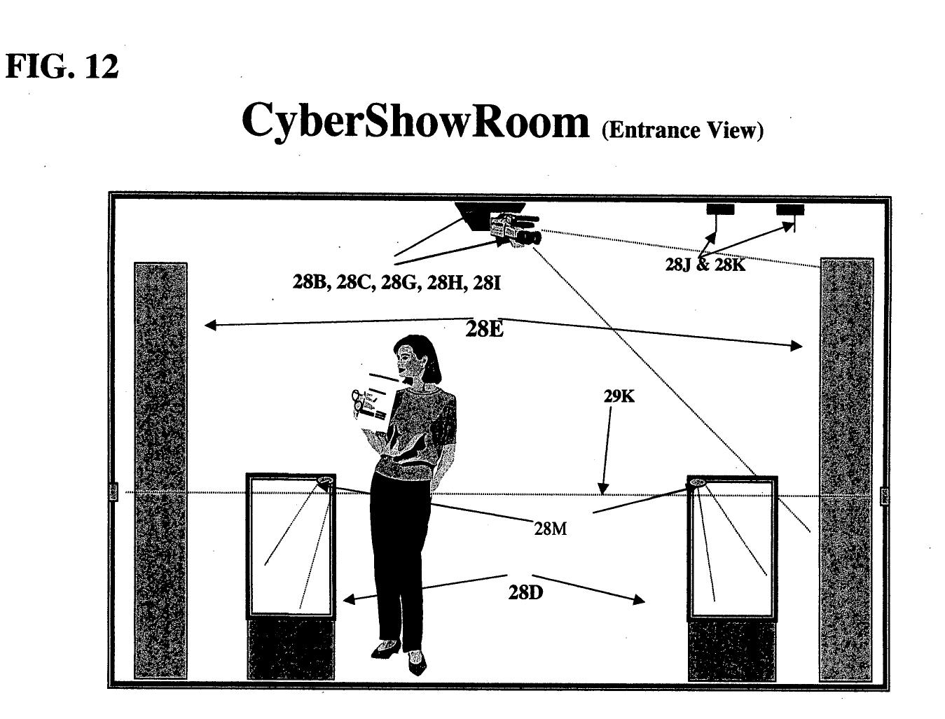

FIG. 12 Illustrates an End View of the CyberShowRoom Concept; It shows an Over-the Counter-Shopper 19 in the interior of a CyberShowroom, or tradeshow booth 28A in which there is installed a CCTV purchasing system in accordance with the present invention. The CCTV purchasing system includes pan, tilt, and zoom cameras that are mounted on a track 28C, or in domes 28B. The pan 28G, tilt 28H, zoom 28I, cameras are movably supported on an elongated tracks or rails or in domes which are suspended from the ceiling or from the walls of the CyberShowRoom. Signals from the cameras and from wireless receiving and transmitting devices such as Buyers and Sellers Sub-Systems are received by the wireless antenna 28J and transmitted from the wireless transmitter antenna 28K whereupon the signals are conveyed to, processed, and digitally recorded in the VPR Appliance 100 or On-site Computer 3A and transmitted as the situation dictates. These cameras and other showcase cameras 28M, allow real-time interactive online viewing of the shop, showroom, or tradeshow booth floor or see inside glass counters 28D and showcases 28E from anywhere in the world. The venue entry and exit detection beam 29K automatically notify shop personnel when an Over-The-Counter shopper 19 enters or leaves the site and makes adjustments to the VPR Appliance 100 or On-site Computer 3A as appropriate. The systems brings movement and interactive functionality to a web site allow users to see and interact with each other and to virtually visit and browse through venues worldwide. In essence, the video systems become proxy eyes and the audio systems become the proxy ears and voices of the clients. Thus, if two of more people are a long distance apart and have a need for face to face discussion, or a need to view information or objects while conducting the face to face discussion, using the technology will save them a great deal of time and money. The systems will be easy to use and relatively low in cost.

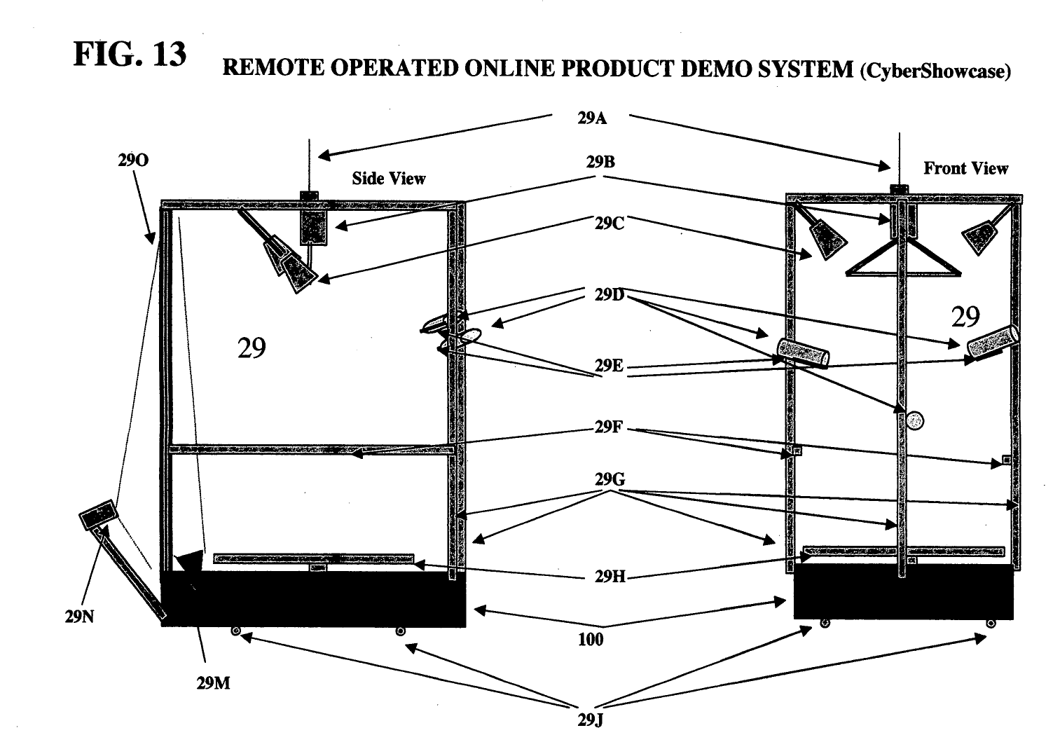

FIG. 13 Illustrates the Remote Operated Online Product Demonstration System (CyberShowCase) Concept Comprising:

A merchandise display apparatus that allows real-time interactive online viewing of objects or information. The apparatus includes means for a shopper to use his/her VPR Appliance 100 or On-site Computer 3A as appropriate and call up the unit, view the merchandise and if desired, get a much better full view of the displayed merchandise by controlling the motorized revolving hanger rack 29B, the motorized revolving platform 29H, cameras 29D, and other components of the unit. During normal operations, the cameras 29D view the merchandise from a position forwardly of the motorized revolving hanger rack 29B and the motorized revolving platform 29H which is above the equipment bay 29I of the unit. Displayed merchandise is illuminated by one or more track mounted floodlights 29C and adjustable light rails 29F. To the CCTV camera 29D, the displayed merchandise stands out in space, the motorized revolving platform 29H and motorized revolving hanger rack 29B being concealed by the direction from which the product is viewed. When it is desired to position the camera above the product the lower edge of the backdrop may be curved forwardly all along the motorized revolving platform 29H thereby concealing the motorized revolving platform from the picture taken. A principal feature of the present invention is the means for changing the scene comprising a multi-colored backlight system 29M, a rear screen projection system 29N, and a white backdrop system 290. The unit's communication system is contained in the VPR equipment bay 29I allows full-duplex communications with signals being conveyed through the system antenna 29A or by some other means. The unit also allows wide adjustability of components, the pan, tilt, and zoom cameras 29D are adjustable in elevation by moving the cameras mounting slide along the adjustable camera racks w/conduit 29G.

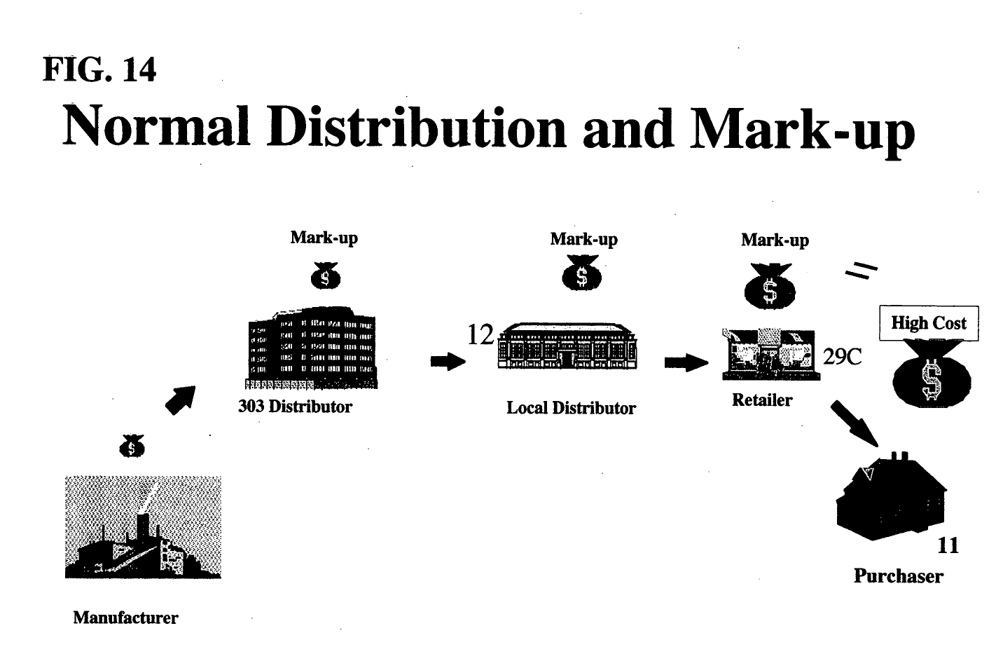

FIG. 14 Illustrates Normal Distribution and Mark-Up, it shows the normal goods, products or services distribution chain and shows how the cost of said goods, products or services increase as they move through the distribution chain from manufacturer to Regional Distribution who add mark-up on to the retailer who add additional mark-up prior to sale to the consumer and/or employee/merchant and/or employer purchaser who pays a considerable amount more than for the item than if purchased directly from manufacturer.

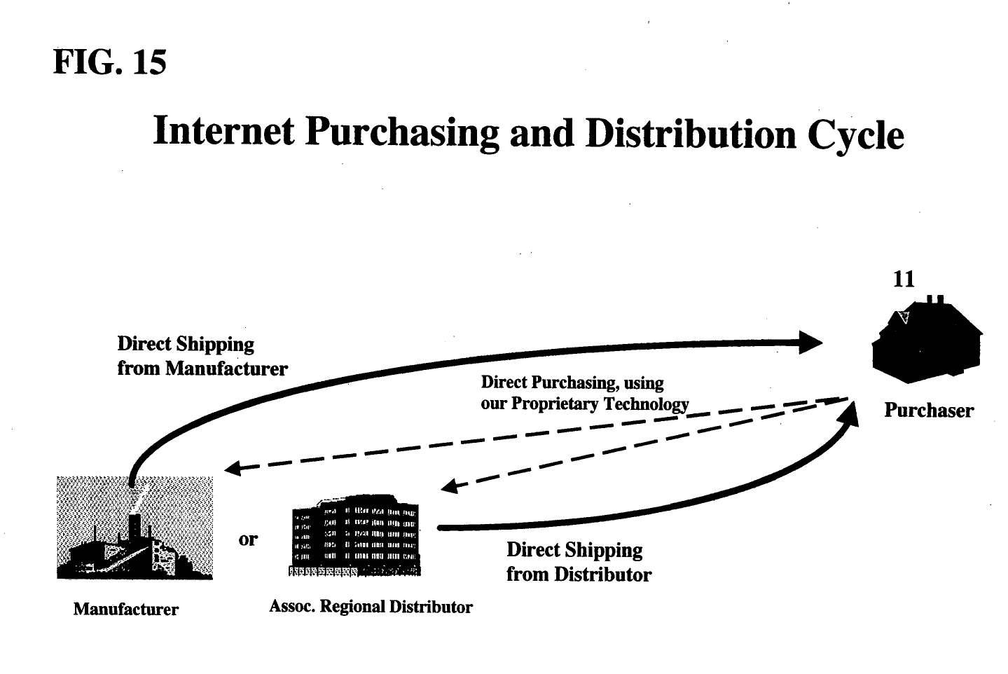

FIG. 15 Illustrates Individual Internet Purchasing and Distribution Cycle of the present invention. It shows the home purchaser 11 in a transaction with manufacturers or regional distributor and direct purchasing using the proprietary technology of the present invention, which is in effect group purchasing yet purchasing as an individual and obtaining volume purchasing prices and benefits while doing so. These transactions will provide high quality goods, products or services that are conveniently organized into departments by brand and category such as food products and services, housing products and services, apparel products and services, transportation products and services, health care products and services, insurance products and services, entertainment and recreation products and services. While the illustration is not actually showing all of the novel items and means brought forth in this invention on this illustration, it is hereby noted that these items are used separately or together for the real-time interactive purchasing transactions to include volume purchasing, or excess inventory purchasing or excess capacity purchasing of goods, products or services.

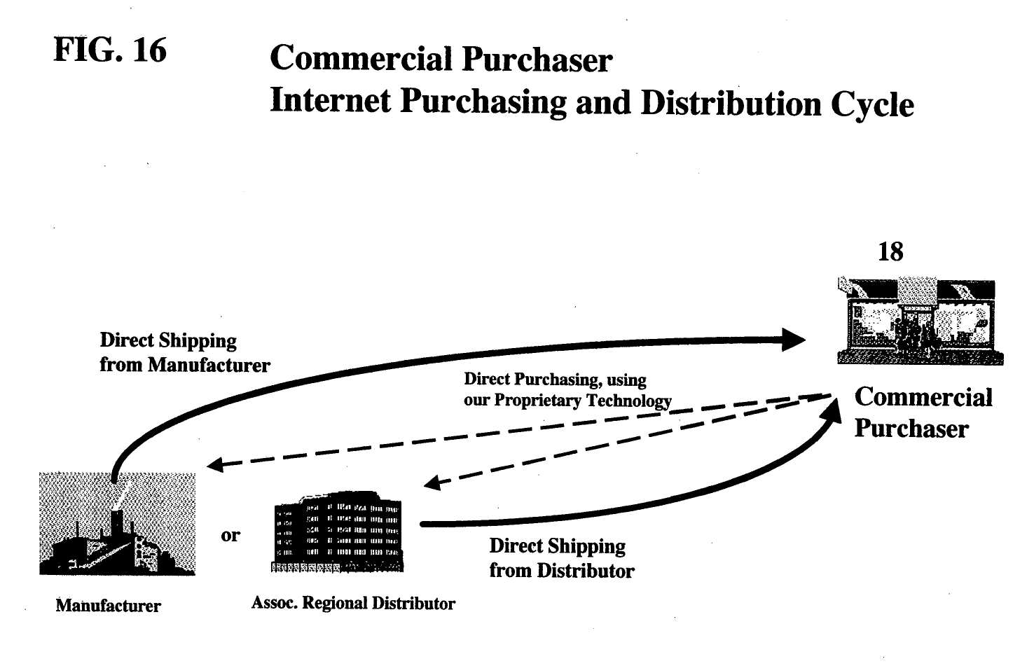

FIG. 16 Illustrates Commercial Purchaser Internet Purchasing and Distribution Cycle of the present invention. It shows the commercial purchaser 18 in a transaction with manufacturers or regional distributor and direct purchasing using the proprietary technology of the present invention, which is in effect group purchasing yet purchasing as an individual and obtaining volume purchasing prices and benefits while doing so. These transactions will provide high quality goods, products or services that are conveniently organized into departments by brand and category such as food products and services, housing products and services, apparel products and services, transportation products and services, health care products and services, insurance products and services, entertainment and recreation products and services. While the illustration is not actually showing all of the novel items and means brought forth in this invention on this illustration, it is hereby noted that these items are used separately or together for the real-time interactive purchasing transactions to include volume purchasing, or excess inventory purchasing or excess capacity purchasing of goods, products or services.

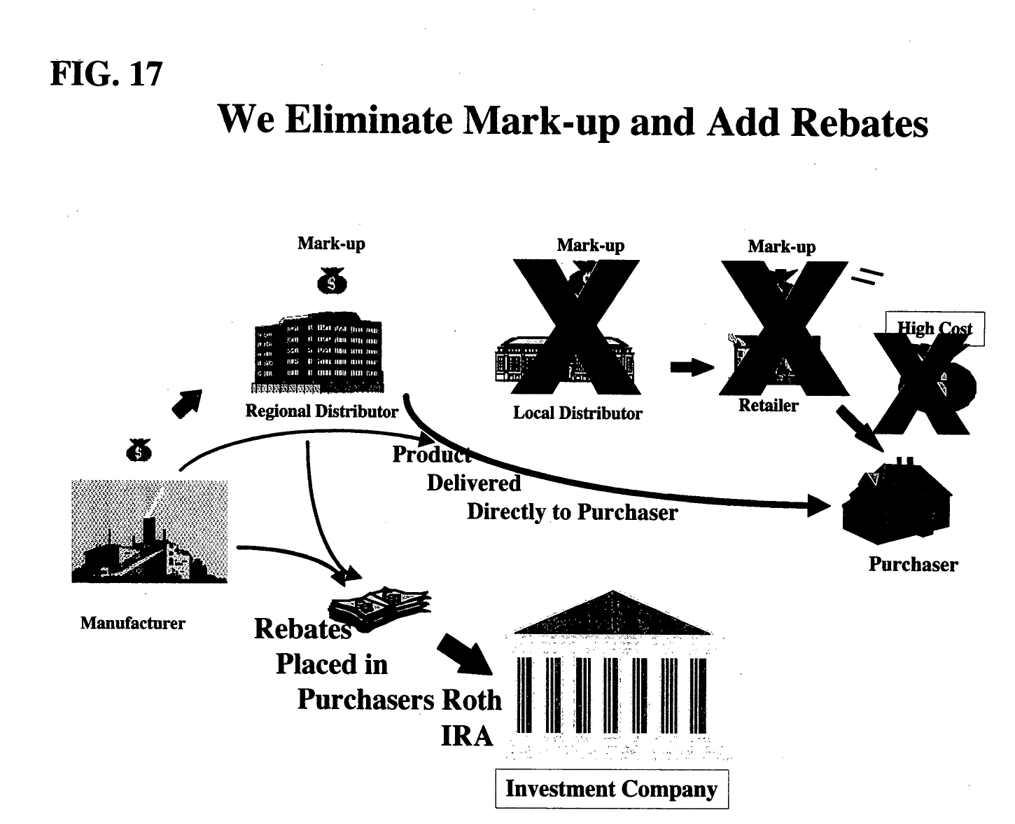

FIG. 17 Illustrates How Mark-Up is Eliminated and Rebates Added—and shows the cumulative affect of using the online real-time interactive ordering and re-ordering Volume Purchasing Rebate Investing technology of the present invention for purchasing transactions. It further shows the eliminations of most mark-up and obtaining rebates, which would normally be this mark-up, and the placing of said rebates into the purchasers investment account.

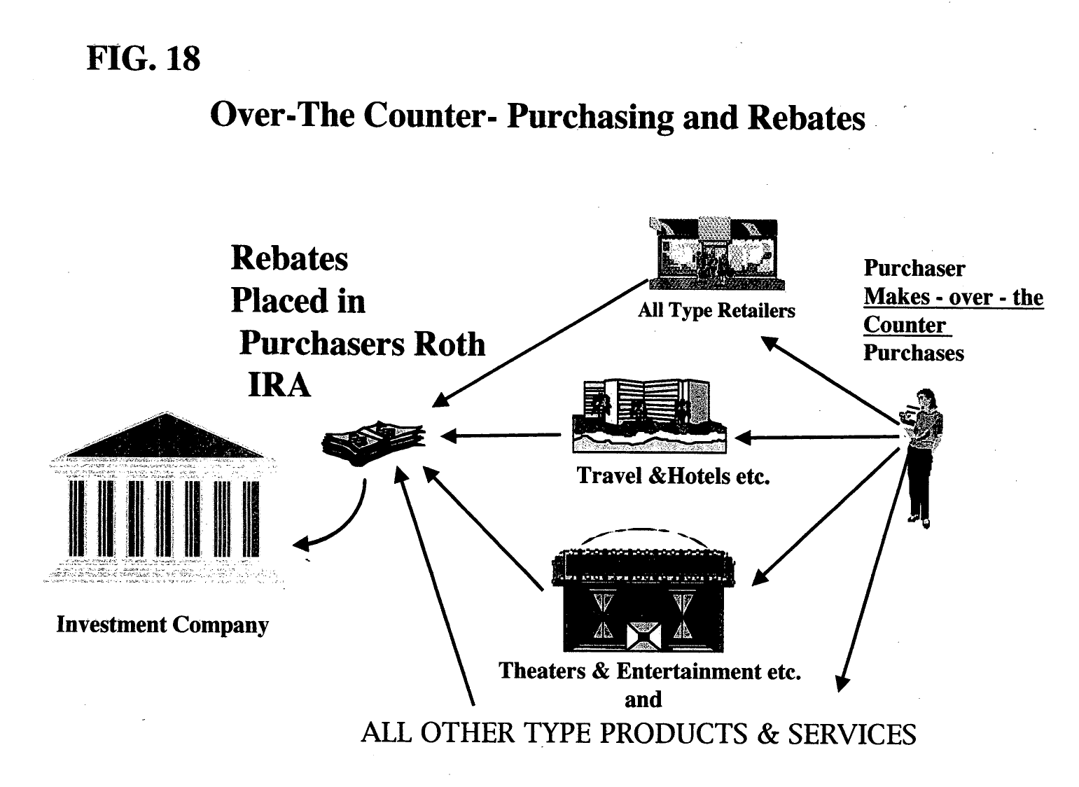

FIG. 18 Illustrates Over-The-Counter Purchasing and Rebates and shows the cumulative affect of using the real-time interactive over-the-counter Volume Purchasing Rebate Investing technology of the present invention for purchasing transactions. It further shows a purchaser making over-the-counter Volume Purchasing transactions of all types goods, products or services and obtaining rebates which are placed into the purchasers investment account.

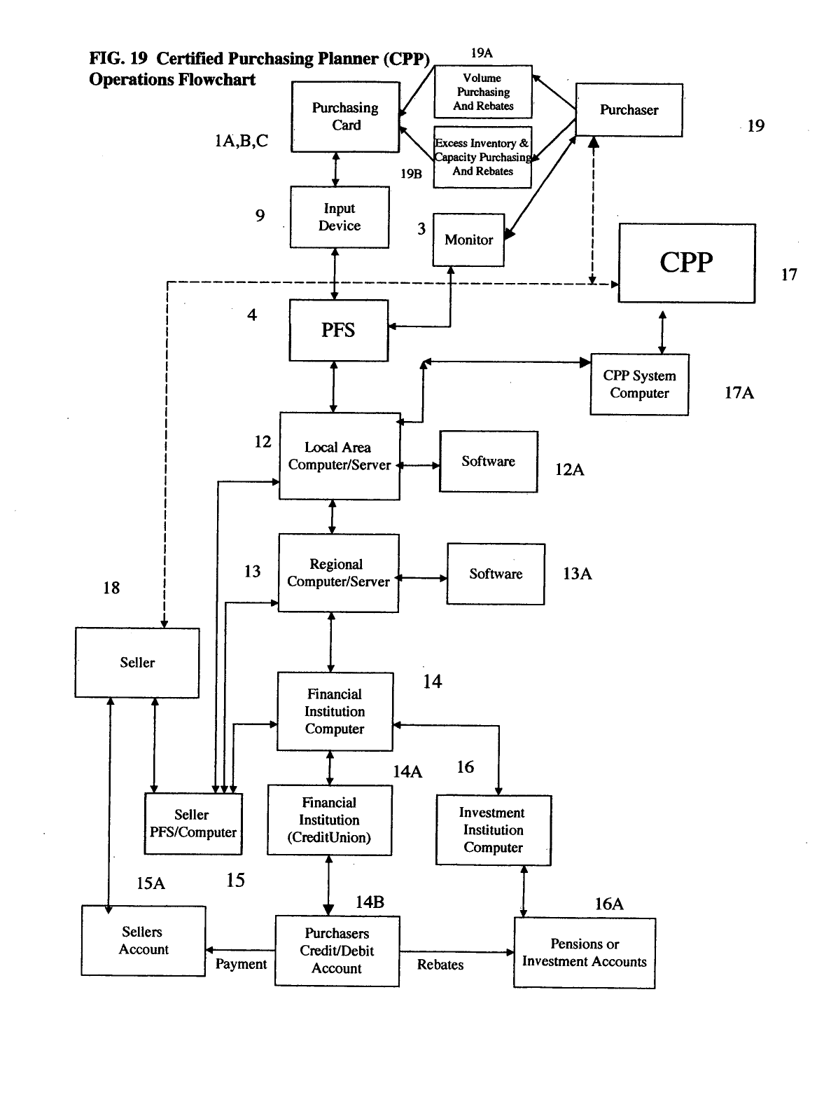

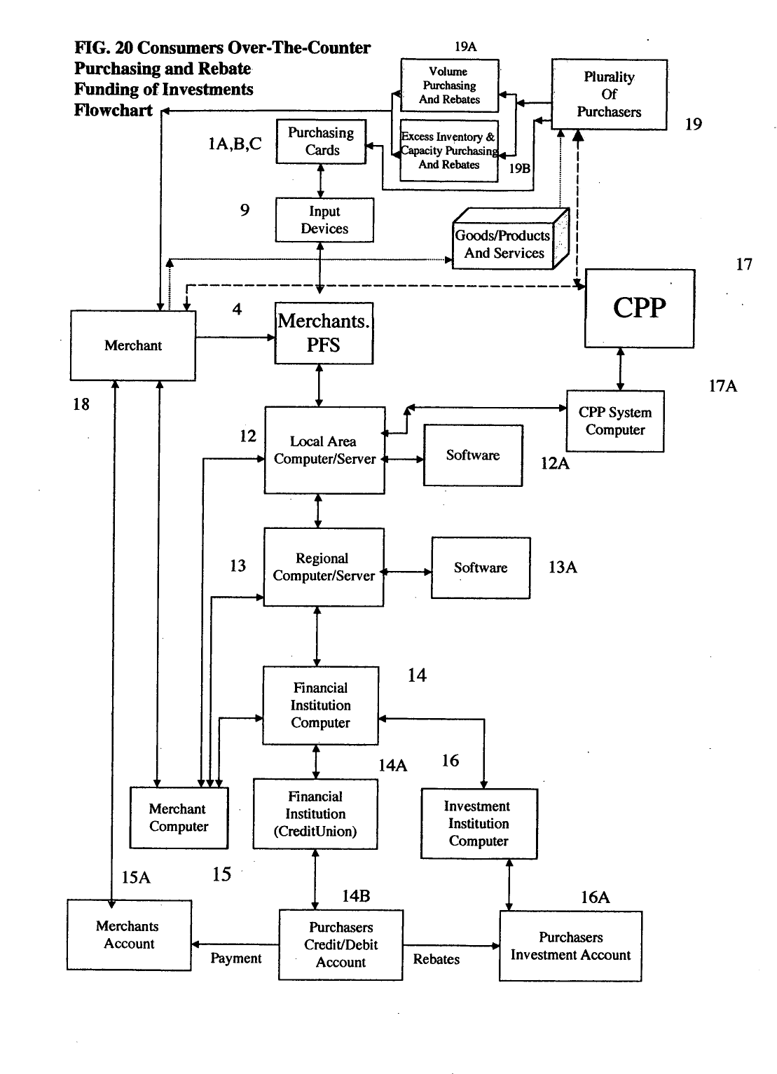

FIG. 19 Illustrates the CPP Consulting to include using the provisions of the Pension Protection Act Of 2006 Flowchart FIG. 20 Illustrates the Consumer and/or employee OTC to include using the provisions of the Pension Protection Act Of 2006 Method & Processing diagram showing the Real-time interactive online goods, product and services purchasing and rebate method and process. Starting from the upper right corner of the diagram, the diagram shows a plurality of purchasers 19 who have an option of volume purchasing and obtaining rebates 19A and/or purchasing excess inventory and obtaining rebates 19B. This option derives from many factors to include, consultation with the Certified Purchasing Planner (CPP) 17, or as a result of a decision based upon researching volume purchasing and excess inventory and capacity purchasing opportunities and options with the ordering and control monitoring unit 3 and the purchasing facilitation systems unit (PFS) 4. Volume purchasing and excess inventory and capacity purchasing opportunities and options can also downloaded to the purchaser based upon the purchasers past purchasing trends and desires. Purchasers will use various purchasing cards to include credit cards 1B, debit cards 1A, smart cards 1C or any other type card suitable for present invention purchasing. Input devices such as card reader 1, and terminal 9, interfacing with the PFS 4, which can allow said credit cards 1B, debit cards 1A, smart cards 1C or any other type card pay for the selected goods, products or service and facilitate rebates for the purchasers investment account. The volume purchasing and excess inventory and capacity purchasing information is conveyed from the PFS 4 to the Area/Local Hub 12 whereupon online purchasing is effected. Area/Local Business Owners can also advertise other goods and services here instead of with costly TV, Yellow Pages etc.

The Certified Purchasing Planner 17, uses a system computer 17A to monitor and advise purchasers on the best means to increase rebates by using the CPP system computer 17A to communicate with the Local Area Computer/Server 12 and the Regional Computer/Server 13 and database software 12A and 13A in which the purchasing transactional information is stored. The databases contain as much as possible the complete universal barcode database and the goods, products and services merchant and/or employers advertise for volume purchasing and for purchasing of excess inventory and capacity. The CPP 17 uses the CPP systems computer 17A to constantly monitor and query computer/servers 12 and 13 for advertisements from the databases which originate in the PFS 4 or Onsite computer 3A of affiliate online merchant and/or employers 12A-12 F producers 13A-13B and wholesalers 13C where purchases are made for appliances, clothing, groceries and many other types of consumer and small business goods and services and manufacturers 13H where non-local wholesale purchases. To include security, fire and carbon monoxide alarm monitoring services, telecommunications, natural gas, electricity, fuel oil, and other HVAC products and services transactions are aggregated so that the CPP System Computer 17A can and does access and utilize the database purchasing transactional information to calculate purchasing trends and desires and the rebate amount that is to be rebated to the purchaser's retirement account for said transaction. Said information is used to consult with purchasers 17B and advise them on the preferred means of purchasing.

The Regional Hub Server 13 networks with the Financial Institution Computer 14 which is located in the system Credit Union 14A (or other financial institution) that administers purchasers credit/debit accounts 14B and facilitates the purchasing funds being debited from the purchasers account at the system credit union 14 with said debited payment going to the sellers account 15A for payment of the purchased goods, products and services, and for rebated funds (which represent the difference between the normal retail price and the volume discount price) are debited from the purchasers account which go to the purchasers investment account 16A. The Certified Purchasing Planner 17, further uses a system computer 17A to analyze merchant and/or employer advertisements and selling trends to advise purchasers 19 on upcoming volume purchasing and excess inventory and capacity purchasing opportunities and also analyze and monitor purchasers accounts in the financial institution computer 14 and consult with financial managers to advise purchasers of their accounts and the best means to increase rebates etc.

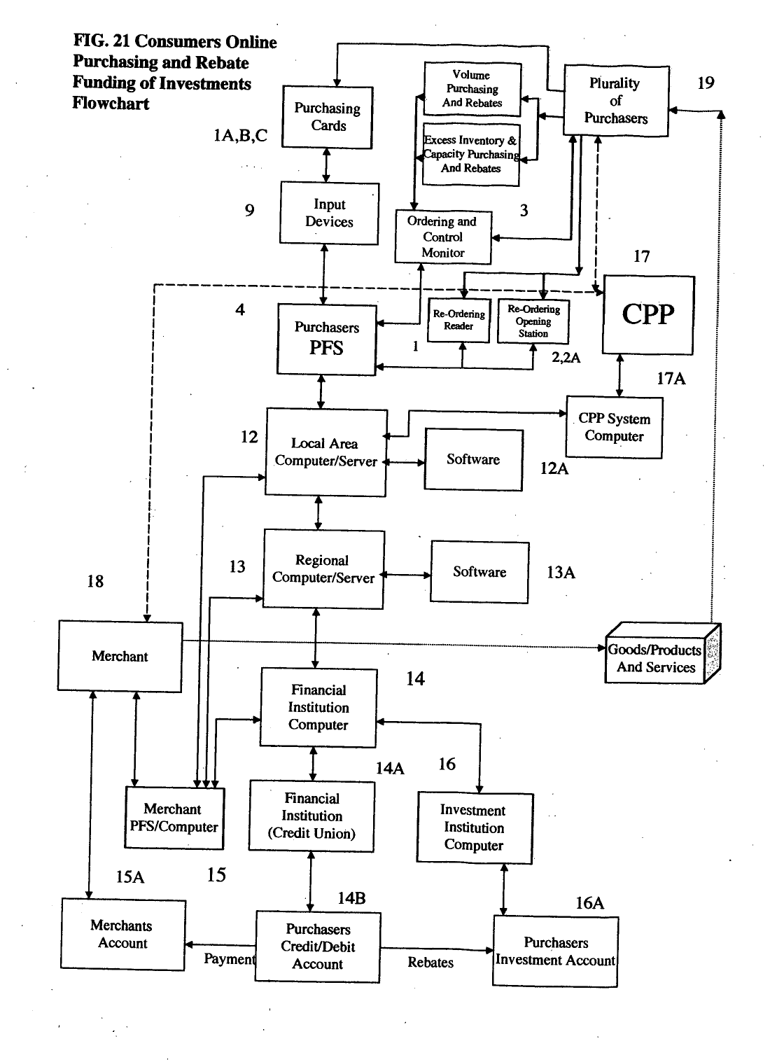

FIG. 21 Illustrates the Consumer and/or employee Online to include using the provisions of the Pension Protection Act Of 2006 Method & Processes diagram showing the Real-time interactive online goods, product and services purchasing and rebate method and process. Starting from the upper right corner of the diagram, the diagram shows a plurality of purchasers 19 who have an option of volume purchasing and obtaining rebates 19A and/or purchasing excess inventory and obtaining rebates 19B. This option derives from many factors to include, consultation with the Certified Purchasing Planner (CPP) 17, or as a result of a decision based upon researching volume purchasing and excess inventory and capacity purchasing opportunities and options with the ordering and control monitoring unit 3 and the purchasing facilitation systems unit (PFS) 4. Volume purchasing and excess inventory and capacity purchasing opportunities and options can also downloaded to the purchaser based upon the purchasers past purchasing trends and desires. The reordering reader 1 or the opening station 2&2A can be used for reordering of goods, products and services

Purchasers will use various purchasing cards to include credit cards 1B, debit cards 1A, smart cards 1C or any other type card suitable for present invention purchasing. Input devices such as card reader 1, and terminal 9, interfacing with the PFS 4, which can allow said credit cards 1B, debit cards 1A, smart cards 1C or any other type card pay for the selected goods, products or service and facilitate rebates for the purchasers investment account. The volume purchasing and excess inventory and capacity purchasing information is conveyed from the PFS 4 to the Area/Local Hub 12 whereupon online purchasing is effected. Area/Local Business Owners can also advertise other goods and services here instead of with costly TV, Yellow Pages etc.

The Certified Purchasing Planner 17, uses a system computer 17A to monitor and advise purchasers on the best means to increase rebates by using the CPP system computer 17A to communicate with the Local Area Computer/Server 12 and the Regional Computer/Server 13 and database software 12A and 13A in which the purchasing transactional information is stored. The databases contain as much as possible the complete universal barcode database and the goods, products and services merchant and/or employers advertise for volume purchasing and for purchasing of excess inventory and capacity. The CPP 17 uses the CPP systems computer 17A to constantly monitor and query computer/servers 12 and 13 for advertisements from the databases which originate in the PFS 4 or Onsite computer 3A of affiliate online merchant and/or employers 12A-12 F producers 13A-13B and wholesalers 13C where purchases are made for appliances, clothing, groceries and many other types of consumer and small business goods and services and manufacturers 13H where non-local wholesale purchases. To include security, fire and carbon monoxide alarm monitoring services, telecommunications, natural gas, electricity, fuel oil, and other HVAC products and services transactions are aggregated so that the CPP System Computer 17A can and does access and utilize the database purchasing transactional information to calculate purchasing trends and desires and the rebate amount that is to be rebated to the purchaser's retirement account for said transaction. Said information is used to consult with purchasers 17B and advise them on the preferred means of purchasing.

The Regional Hub Server 13 networks with the Financial Institution Computer 14 which is located in the system Credit Union 14A (or other financial institution) that administers purchasers credit/debit accounts 14B and facilitates the purchasing funds being debited from the purchasers account at the system credit union 14 with said debited payment going to the sellers account 15A for payment of the purchased goods, products and services, and for rebated funds (which represent the difference between the normal retail price and the volume discount price) are debited from the purchasers account which go to the purchasers investment account 16A. The Certified Purchasing Planner 17, further uses a system computer 17A to analyze merchant and/or employer advertisements and selling trends to analyze purchasers 19 on upcoming volume purchasing and excess inventory and capacity purchasing opportunities and also analyze and monitor purchasers accounts in the financial institution computer 14 and consult with financial managers to advise the purchaser of their accounts and the best means to increase rebates etc.

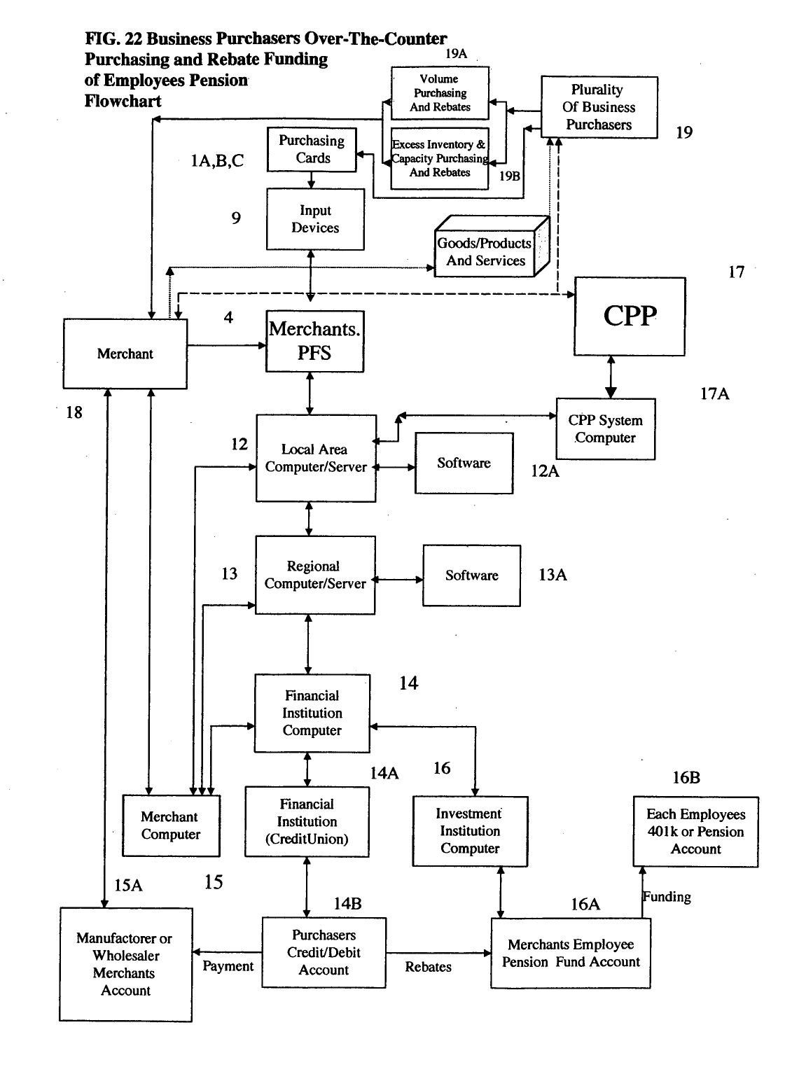

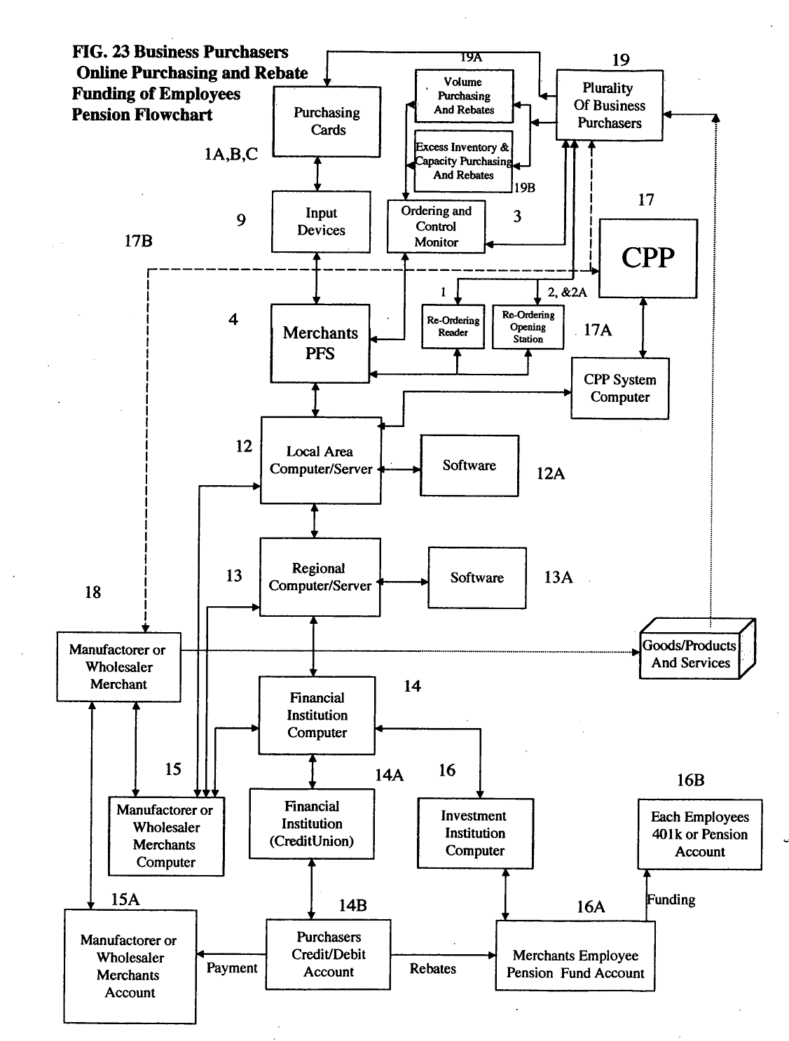

FIG. 22 Illustrates the Business OTC to include using the provisions of the Pension Protection Act Of 2006 Method & Processes diagram showing the purchasing saving investing system for assisting merchant and/or employer members of Organizations in obtaining funds for their employees savings and investment accounts while establishing or harnessing the group purchasing power of said organizations, yet allowing for each member to use said group purchasing power while buying individually and while entering into transactions with other merchant and/or employers for the volume purchasing or excess inventory purchasing or excess capacity purchasing of goods, products or services, said purchasing saving investing system comprising:
(a) at least one Real-time interactive online goods, product and services purchasing and rebate means;
(b) at least one plurality of purchasers who have an option of volume purchasing and obtaining rebates 19A and/or purchasing excess inventory and obtaining rebates 19B. This option derives from many factors to include, consultation with the Certified Purchasing Planner (CPP) 17, or as a result of a decision based upon researching volume purchasing and excess inventory and capacity purchasing opportunities and options with the ordering and control monitoring unit 3 and the purchasing facilitation systems unit (PFS) 4. Volume purchasing and excess inventory and capacity purchasing opportunities and options can also downloaded to the purchaser based upon the purchasers past purchasing trends and desires.

Purchasers will use various purchasing cards to include credit cards 1B, debit cards 1A, smart cards 1C or any other type card suitable for present invention purchasing. Input devices such as card reader 1, and terminal 9, interfacing with the PFS 4, which can allow said credit cards 1B, debit cards 1A, smart cards 1C or any other type card pay for the selected goods, products or service and facilitate rebates for the purchasers investment account. The volume purchasing and excess inventory and capacity purchasing information is conveyed from the PFS 4 to the Area/Local Hub 12 whereupon online purchasing is effected. Area/Local Business Owners can also advertise other goods and services here instead of with costly TV, Yellow Pages etc.

The Certified Purchasing Planner 17, uses a system computer 17A to monitor and advise purchasers on the best means to increase rebates by using the CPP system computer 17A to communicate with the Local Area Computer/Server 12 and the Regional Computer/Server 13 and database software 12A and 13A in which the purchasing transactional information is stored. The databases contain as much as possible the complete universal barcode database and the goods, products and services merchant and/or employers advertise for volume purchasing and for purchasing of excess inventory and capacity. The CPP 17 uses the CPP systems computer 17A to constantly monitor and query computer/servers 12 and 13 for advertisements from the databases which originate in the PFS 4 or Onsite computer 3A of affiliate online merchant and/or employers 12A-12 F producers 13A-13B and wholesalers 13C where purchases are made for appliances, clothing, groceries and many other types of consumer and small business goods and services and manufacturers 13H where non-local wholesale purchases. To include security, fire and carbon monoxide alarm monitoring services, telecommunications, natural gas, electricity, fuel oil, and other HVAC products and services transactions are aggregated so that the CPP System Computer 17A can and does access and utilize the database purchasing transactional information to calculate purchasing trends and desires and the rebate amount that is to be rebated to the purchaser's retirement account for said transaction. Said information is used to consult with purchasers 17B and advise them on the preferred means of purchasing.

The Regional Hub Server 13 networks with the Financial Institution Computer 14 which is located in the system Credit Union 14A (or other financial institution) that administers purchasers credit/debit accounts 14B and facilitates the purchasing funds being debited from the purchasers account at the system credit union 14 with said debited payment going to the sellers account 15A for payment of the purchased goods, products and services, and for rebated funds (which represent the difference between the normal retail price and the volume discount price) are debited from the purchasers account which go to the merchant and/or employers employee pension fund account 16A whereupon, funds are divided and further credited to employee 401k or pension accounts 16B. The Certified Purchasing Planner 17, further uses a system computer 17A to analyze merchant and/or employer advertisements and selling trends to advise purchasers 19 on upcoming volume purchasing and excess inventory and capacity purchasing opportunities and also analyze and monitor purchasers accounts in the financial institution computer 14 and consult with financial managers to advise purchasers of their accounts and employees on their accounts 16B and the best means to increase rebates etc.

FIG. 23 Illustrates the Business Online to include using the provisions of the Pension Protection Act Of 2006 Method & Processes diagram showing the Real-time interactive online goods, product and services purchasing and rebate method and process. Starting from the upper right corner of the diagram, the diagram shows a plurality of purchasers 19 who have an option of volume purchasing and obtaining rebates 19A and/or purchasing excess inventory and obtaining rebates 19B. This option derives from many factors to include, consultation with the Certified Purchasing Planner (CPP) 17, or as a result of a decision based upon researching volume purchasing and excess inventory and capacity purchasing opportunities and options with the ordering and control monitoring unit 3 and the purchasing facilitation systems unit (PFS) 4. Volume purchasing and excess inventory and capacity purchasing opportunities and options can also downloaded to the purchaser based upon the purchasers past purchasing trends and desires. The reordering reader 1 or the opening station 2&2A can be used for reordering of goods, products and services

Purchasers will use various purchasing cards to include credit cards 1B, debit cards 1A, smart cards 1C or any other type card suitable for present invention purchasing. Input devices such as card reader 1, and terminal 9, interfacing with the PFS 4, which can allow said credit cards 1B, debit cards 1A, smart cards 1C or any other type card pay for the selected goods, products or service and facilitate rebates for the purchasers investment account. The volume purchasing and excess inventory and capacity purchasing information is conveyed from the PFS 4 to the Area/Local Hub 12 whereupon online purchasing is effected. Area/Local Business Owners can also advertise other goods and services here instead of with costly TV, Yellow Pages etc.

The Certified Purchasing Planner 17, uses a system computer 17A to monitor and advise purchasers on the best means to increase rebates by using the CPP system computer 17A to communicate with the Local Area Computer/Server 12 and the Regional Computer/Server 13 and database software 12A and 13A in which the purchasing transactional information is stored. The databases contain as much as possible the complete universal barcode database and the goods, products and services merchant and/or employers advertise for volume purchasing and for purchasing of excess inventory and capacity. The CPP 17 uses the CPP systems computer 17A to constantly monitor and query computer/servers 12 and 13 for advertisements from the databases which originate in the PFS 4 or Onsite computer 3A of affiliate online merchant and/or employers 12A-12 F producers 13A-13B and wholesalers 13C where purchases are made for appliances, clothing, groceries and many other types of consumer and small business goods and services and manufacturers 13H where non-local wholesale purchases. To include security, fire and carbon monoxide alarm monitoring services, telecommunications, natural gas, electricity, fuel oil, and other HVAC products and services transactions are aggregated so that the CPP System Computer 17A can and does access and utilize the database purchasing transactional information to calculate purchasing trends and desires and the rebate amount that is to be rebated to the purchaser's retirement account for said transaction. Said information is used to consult with purchasers 17B and advise them on the preferred means of purchasing.

The Regional Hub Server 13 networks with the Financial Institution Computer 14 which is located in the system Credit Union 14A (or other financial institution) that administers purchasers credit/debit accounts 14B and facilitates the purchasing funds being debited from the purchasers account at the system credit union 14 with said debited payment going to the sellers account 15A for payment of the purchased goods, products and services, and for rebated funds (which represent the difference between the normal retail price and the volume discount price) are debited from the purchasers account which go to the merchant and/or employers employee pension fund account 16A whereupon, funds are divided and further credited to employee 401k or pension accounts 16B. The Certified Purchasing Planner 17, further uses a system computer 17A to analyze merchant and/or employer advertisements and selling trends to advise purchasers 19 on upcoming volume purchasing and excess inventory and capacity purchasing opportunities and also analyze and monitor purchasers accounts in the financial institution computer 14 and consult with financial managers to advise purchasers of their accounts and employees on their accounts 16B and the best means to increase rebates etc.

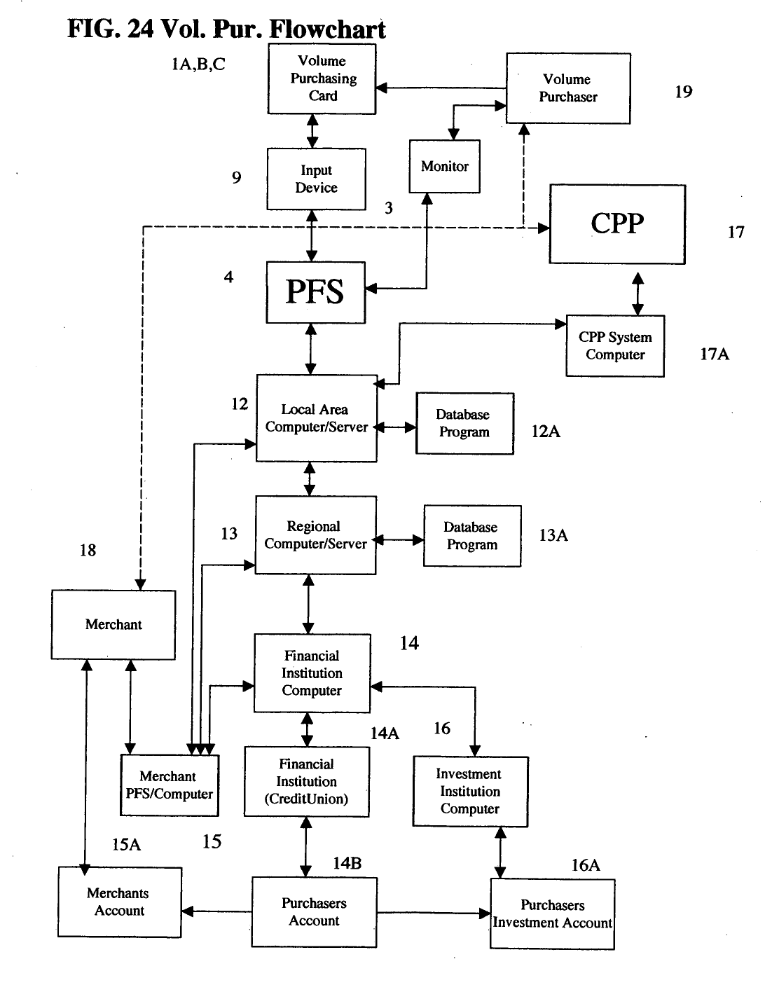

FIG. 24 Illustrates the Volume Purchasing to include using the provisions of the Pension Protection Act Of 2006 Flowchart Purchasing, to include using the provisions of the Pension Protection Act Of 2006

The Invention encompasses technology that will greatly facilitate the sale of goods and services while providing customers with a means to painlessly fund their Individual Retirement Accounts. The present invention will facilitate the offering of tens of thousands of products from several hundred manufacturers through online stores on the Internet, through [Over-The-Counter Purchase] Over-The-Counter Volume Purchase with local merchant and/or employers and contractors and through Real-time Interactive purchases with merchant and/or employers and wholesalers around the world. The Invention provides an online shopping experience that incorporates traditional shopping mall and mail order features into an interactive, easy-to-use and compelling online environment. Online technology, and the Internet in particular, is an advantageous medium for the selling of merchandise relative to traditional retail stores and mail-order catalogs. Leveraging online technology and the global reach of the Internet, the online retailing and wholesaling model of the present invention provides virtually unlimited online shelf space and the ability to reach a geographically unlimited customer base, without the costs associated with constructing traditional retail stores and distributing mail-order catalogs. The Invention's strategy is to offer quality merchandise, provide effective customer service, and capitalize on the inherent economies of the online retailing model by allowing the purchaser to purchase excess inventory and excess capacity from merchant and/or employers and vendors of all types.

The Invention provides for transacting with merchant and/or employer in online stores over the Internet or by over-the-counter stores in malls or other venues. The Invention's online stores will provide high quality color video camera images and detailed information relating to products or services that are conveniently organized into departments by brand and category such as food products and services, housing products and services, apparel products and services, transportation products and services, health care products and services, insurance products and services, entertainment and recreation products and services.

Shoppers can search for, browse and select products throughout the stores and place selected merchandise in virtual shopping carts that facilitates the process of collecting items, subtotaling purchases and reaching the purchase decision. Furthermore, The Invention will establish strategic relationships with manufacturers, which allow most products to be rapidly shipped directly from the manufacturer. Manufacturer direct shipping enables the VPR Organization by way of the Certified Purchasing Planner to assist merchant and/or employers in avoiding inventory-related risks; limit overhead costs and provides prompt delivery. As part of its marketing strategy, the VPR Organization using the Certified Purchasing Planner will form strategic alliance with local merchant and/or employers and contractors pursuant to a marketing agreement. In addition, the Certified Purchasing Planner plans to establish strategic alliances with other online companies and begin a targeted advertising campaign to attract additional customers to the its online stores. It is believed that both online and traditional media exposure are critical to maximizing brand recognition and driving traffic to its online stores.

Products

The present invention's brick and mortar stores or store on the Internet will offer tens of thousands of products from several hundred manufacturers. Products or services range widely in price Internet products or services will be featured with a high quality color picture and detailed information relating to product or service specifics, service care or purchasing instructions. The present invention's store on the Internet is designed to accommodate the needs of both the browser and the directed shopper. The browser can view an array of products or services by simply clicking on one of the feature departments or service categories. The directed shopper is able to quickly locate a specific product or service by category or brand by using the store's search function or store directory. By clicking on the picture of a product or service, the customer is presented with detailed information relating to product or service specifics, service, and care or purchasing instructions.

The present invention seeks to provide a compelling shopping environment that will attract customers and encourage shoppers to purchase. The present invention intends to add sound and video features to its Internet store that will guide shoppers through the store and announce special offers. The present invention also aims to make the shopping experience as simple and convenient as possible. The present invention features a virtual shopping bag function that allows the shopper to accumulate merchandise for purchase while browsing through the store. Items can be added to or subtracted from the shopping cart at any time. As a registered member, the customer is able to retain items in the shopping cart indefinitely, even after leaving the store or logging-off. After selecting an item to purchase, the customer is prompted to complete an order. In choosing a payment method when placing an order, customers have the option of securely submitting credit card information online or telephoning or faxing the information to customer service representatives. The present invention also provides the option of payment by check or money order. The present invention sends e-mail notifications that confirm the order and shipment and promote special offers and events.

Worldwide Shopping and Buying can be accomplished whereby the VPR Organization will acquire or affiliate with all types of stores, shops, and other of establishments from around the world. The VPR Organization will use these stores, shops, and establishments as CybershowRooms etc., and ship goods to customers from more centralized warehouses etc.

[The Purchasing Facilitation System (PFS)] The Volume Purchase Rebate (VPR) Appliance is a powerful modular assembly comprising microprocessor and other devices that greatly increases the efficiency of the purchasing process and includes sub-circuits, relays other devices, sub-systems and components that compress and decompress bandwidth and connects to POTS, and wide bandwidth wireless, DSL, Fiber Optic, Cable, Satellite or any other signal conveying means. The VPR Appliance then allows the transmission and reception of real-time digital, optical, analog or any other type of data, video and audio signals or information to better facilitate the buying and selling of goods and services and enhancing the safety and security of buyers and sellers.

The present invention will interface with emerging technologies and new developments in web technologies with the objective of optimizing customer interfaces, web site features and operational systems. Technologies including systems that will enrich the online shopping experience and deliver more effective marketing messages, to provide customized services to shoppers in stores on the Internet. The present invention also encompasses methods to improve bandwidth technology that makes Online purchasing a more real time video experience for both, buyer and seller.

High quality data sensors, of varying type, are used to detect product information such as bar codes and other data. The sensors sense the data by various means such as optical scan, proximity, wigant, and processed and pre-amplifies the signal in the data processing circuit, from there, the data is then carried to data transmission components and. over the wires or by other means to the central processing unit located in the Volume Purchase Rebate System. There the data is further transmitted by radio wave, by satellite communications, by cellular telephone, or by regular telephone lines or by other means of communications to the VPR Computer. There, it is received and processed by and appropriate volume purchasing is effected.

The Product Opening and Unsealing Station consists of opening means and data sensing means. As a can rotates as it is being opened, the data sensor automatically reads the bar-code data; this data is automatically conveyed to the processing unit where it is stored in memory to be compiled and accessed as needed. As this data is accumulated, it forms the basis for future re-ordering of products.

The Product and Services Ordering and Re-Ordering System interfaces with the VPR Appliance or On-site Computer, these devices combined, are the first devices developed from the ground up to aid owners and managers of small to medium sized residential and commercial buildings coordinate and better manage their purchasing of products and services to include various consumer and/or employee goods and services to include security, fire and carbon monoxide monitoring, telecommunications, natural gas, electricity, water, HVAC, and other energy conservation, building safety and maintenance operations. The VPR Appliance or On-site Computer meters, monitors and controls all of the building systems relating to these operations and uses powerful software to integrate all systems information into a single server database located at local, area or regional VPR Computers.

The deregulation of utilities has brought about a need to change and improving the means, methods for managing utilities and protecting the inhabitants of buildings in urban areas. The system allows inhabitants to save on utilities and security while enjoying the comfort and safety of their buildings. The system combines into one device a method and apparatus to remotely monitor, control and manage the environment of buildings and to detect fire, smoke and intrusion; to measure fuel oil, water, natural gas and electricity; to remotely control the operation of furnaces, boilers, heat pumps, air conditioners, lights, appliances and hot water heaters; to prevent foul odors and clogging of plumbing pipes and the flooding of these buildings due to the building of grease, gelatin and other waste in these plumbing pipes to clog.

The VPR Appliance or On-site Computer also includes systems to monitor purchasing peaks and valleys during the year to facilitate the purchasing and selling of excess inventory and capacity.

[On Line Systems Technology] Purchasing Agent Sub-System to Include Using the provisions of the Pension Protection Act Of 2006;

Comprises said the VPR Organization and the Certified Purchasing Planner (CPP) who are the purchasers' personal volume purchasing agent and assists purchasers in obtaining all volume purchasing benefits and in doing so, they use the sophisticated information services delivery and shopper tracking systems by integrating third-party systems. These information systems can be viewed as the integrated systems to include using the provisions of the Pension Protection Act Of 2006: (i) a publishing system, (ii) a selling system and (iii) CCTV System (iv) and order processing system, all of which are supported by Relational Databases and other software in the VPR appliances and VPR Hub Computers.

Publishing Data Module. The publishing system contains information about all items in the present invention's stores that have been offered for VPR type purchasing, including retail price, cost, rebates, color and size characteristics, group information and all manufacturer related information. Once the manufacturers have offered their products to the present invention, the data sets are published (downloaded) to the present invention's purchasers, both online and over-the-counter.

Seller Data Module. The present invention's Purchasing Agent system functions with merchants of brick and mortar stores as well as merchants of stores on the Internet, and are designed to give customers a convenient and efficient means to effect their volume purchases. It will use copyrighted software and proprietary Internet web servers to handle the volume purchasing transactional events, queries and updates to the SQL Server database. The Purchasing Agent system software is also designed to give customer service representatives, who are the Certified Purchasing Planners (CPP's) of the present invention, instant access to all merchant goods, products and services information, to automatically update all changes to merchant and/or employers and inform the merchant and/or employer of sales status by automated e-mail communications. The CPP will also use the selling system to assist customers with their volume purchasing efforts by informing them of all opportunities in their respective areas. The CPP will also use the Purchasing Agent system to assist customers in increasing their rebates by also keeping them informed of opportunities in their areas. All transactions are secured by using the encryption means of the VPR Appliance or On-site Computer Ordering Data Module. The present invention's Purchasing Agent ordering system retrieves ordering information from selling systems, validates VPR credit cards, processes the orders, creates and issues purchase orders to merchant and/or employers and manufacturers and handles all post-sale marketing efforts. The ordering system also allows for orders to be taken over the telephone. The ordering system software is also designed to give customer service representatives, who are the [customer service representatives] Certified Purchasing Planners (CPP's) of the present invention, instant access to all customer information, to automatically update all changes to a customer's order and inform the customer of order status by automated e-mail communications.

The CPP will also use the ordering system to assist customers with their volume purchasing efforts by also keeping them informed of opportunities in their areas. The CPP will also use the ordering system to assist customers in increasing their rebates by also keeping them informed of opportunities in their areas. The CPP's and marketing departments can access customer profile information to search and analyze customer demographics and buying patterns in order to suggest new programs and offers to customers. The system will also communicate with the merchant and/or employers or warehousing facilities in real time for updates on order shipments and stock status positions.

CyberShowRoom

This segment of the present invention interfaces with the VPR Appliance or On-site Computer and relates generally to closed-circuit television purchasing systems and pertains more particularly to such systems in which a television camera is mounted on a carriage for movement along a rail or track and in which the system is subject to automatic control by a computer or the like.

It is known to provide closed circuit television purchasing systems using either cameras in a fixed location or cameras that are mounted for movement along a track, dome or stand It is also known, in the case of a system using a fixed-position camera, to provide automatic acquisition of a product object in response to an command signal or the like. Assuming that data has previously been stored in the control system to indicate the required direction of view and appropriate zoom and/or focus condition for the camera to provide an image of the product, the control system can implement an immediate adjustment to the camera direction, zoom condition, etc. so that an image of the product is provided by the camera within a very short time.

However, when the system utilizes a moving camera, such as a camera mounted on a carriage that travels along a rail, the camera may be located at any arbitrary position in its range of movement at the time a command is received. Since the camera location at the time of the command cannot be known in advance, it is not possible to store in advance data defining a particular direction and zoom condition of the camera, which will enable the camera to provide an image of the product from the position of the camera at the time of the command.

The present invention also includes methods of simulating the motion of real-time shopping through the use of pan, tilt and zoom cameras, which enhance product presentation through motion etc. In the case of an operator-attended purchasing system, the human operator may attempt to respond to the command signal by operating system controls to reposition the camera carriage and to adjust the camera direction, etc. so that an image of the product is obtained. However, the variety of possible camera positions and directions-of-view may lead to disorientation on the part of the operator. Also, if the system is set up with multiple products for which commands may be actuated, the operator may have difficulty identifying the particular product to which the command pertains. As a result, the human operator's response to the command may be too slow, thus causing the operator to become frustrated.

While it might be proposed to define a predetermined position along the track to which the camera should be moved in response to an command which pertains to a particular product, and then an appropriate direction of view and zoom condition data could also be stored for providing an image of the product from that predetermined position, such an approach carries the disadvantage that a significant amount of time may be required to move the carriage to the predetermined position from the position of the carriage at the time the command is received. Even if automatic camera direction and zoom adjustments are performed before or during carriage movement so that the camera will be in an appropriate orientation and zoom condition to provide the image of the product as soon as the predetermined carriage position is reached, still product acquisition cannot take place during the time the carriage is in motion, and product acquisition thus may be substantially delayed.

The present invention also includes means and methods whereby shoppers/buyers virtually shop at regional as well as international establishments without leaving the comfort of their homes and businesses. However, purchased products are pre-positioned at strategic locations to speed up delivery to the purchaser etc.

CyberShowCase

This segment of the present invention interfaces with the VPR Appliance or On-site Computer and relates to a new and improved merchant and/or employer's CyberShowCase which has for its principal purpose to provide a moving and adjustable CCTV system for motorized revolving platform and hanger systems on which the product to be pictured rests and also for a multi-colored backdrop system which is positioned behind the product in the line of sight of the camera. The multi-colored backdrop is preferably illuminated from behind with rear view projection or from the front with either a white light or a light having appropriate color filter. The projectioned or multi-colored backdrop provides a wide variety of scenes as background for the product being photographed.

The present invention encompasses means and methods of giving the presented product motion through the use of pan-tilt-zoom cameras and moving platforms and racks located in the CyberShowCase. Not only do these devices provide motion, but they also present multiple viewing angles to make product presentation more appealing.

The CyberShowCase may be used either as a stationary or mobile showcase. Accordingly, it is a principal product of the present invention to provide an equipment bay on wheels, which contains the equipment and systems to facilitate CCTV production.

Another feature of the present invention is the fact it is readily transportable, easily adjustable in many different positions and adaptable to a wide variety of conditions to photography products.

CyberSalesperson

The present invention encompasses means and methods of simulating the shopper actually being in the showroom with the CyberSalesPerson showing the product. The Buyers Sub-System includes a product opening/unsealing station with a ordering sub-system with a barcode type reader, and a RF type reader, a camera system with microphone and video display monitor interfaced with the VPR Appliance or On-site Computer that communicates by wireless, online or otherwise with the Seller Sub-System (which includes various cameras such as; a finger bracket camera, eyeglass, cap, beeper etc. covert cameras and various other camera systems which are mounted on tripods or any other type stand or mount). The CyberSalesPerson is also equipped with a R/T capable Headset that has a microphone, earphones and mini-radio unit w/antenna.

The CyberSalesPerson is equipped with the means to effectively communicate (audio and video) online real-time with the shopper (retail customer) or buyer (wholesale customer) being serviced. These systems interface with the VPR Appliance or On-site Computer or the CyberShowcase or CyberShowroom.

### The Volume Purchase Rebate Investing Pension Protection Plan

Detailed Summary of Tax, Trade and Other Provisions

Tax Provisions

The Volume Purchase Rebate Investing Pension Protection Plan includes a number of significant tax incentives to enhance retirement savings for mill ions of Americans, including:

1. Permanent Retirement and Savings Incentives

The Economic Growth and Tax Relief Reconciliation Act of 200J (EGTRRA) substantially increased pension and individual retirement account (IRA) contribution limits through 2010 as well as making other improvements in pensions and retirement savings through enhanced vesting, portability and reduced regulatory burdens. The provision makes these favorable changes permanent. The provision also indexes the income limits for traditional, spousal and Roth IRAs to prevent these benefits from being eroded by inflation.

2. Saver's Credit Made Permanent

The provision makes permanent the Saver's Credit of up to $2,000. Without this extension, the credit will not be available after 2006. The provision also indexes the Saver's Credit income limits to prevent this benefit from being eroded by inflation.

3. Drop Plans for Public Safety Employees

The provision waives the 10 percent early withdrawal penalty for distributions to public safety employees over age 50 (including police and firemen) who may retire early.

4. Direct Deposit of Tax Refunds into IRAs

The provision requires the IRS to establish procedures for depositing tax refunds directly into an IRA.

5. Automatic Enrollment

The provision creates a safe harbor to encourage employers to offer automatic enrollment in employer-sponsored defined contribution pension plans, which will encourage employee participation.

6. Treatment of IRA Contributions for Guard and Reservists Called to Active Duty

The provision provides that distributions from an IRA or pension plan taken by members of the National Guard and Reserves called to active duty through 2007 are not subject to early withdrawal penalties. Withdrawn amounts may be repaid to the IRA or pension plan within two years of the distribution without regard to the annual contribution limit.

7. Long Term Care/Annuity Products

The provision authorizes a new insurance product, which allows annuities to carry a long-term care rider, so that annuity earnings can also be used to provide coverage against long-term care needs.

8. Public Safety Officer Early Withdrawals for Health and Long Term Care Insurance

Public safety officers who retire or become disabled may make tax-free distributions of up to $3,000 annually from their governmental pension plans if the distribution is used to purchase health or long-term care insurance.

9. Corporate-Owned Life Insurance (COLI)

The provision codifies “best practices” standards for corporate-owned life insurance.

10. Clarification of Treatment of Tribal Pension Plans

The provision clarifies the law regarding tribal pension plans. The clarification provides that employees engaged in essential government functions (but not commercial operations such as casinos, hotels or marinas) will be treated as government employees under the Code and under ERISA.

11. Black Lung Benefit Trust Funds

The provision eliminates the aggregate limit on the use excess funds from black lung benefit trusts to be used to fund retiree health for coal miners.

12. Transfers of Excess Defined Benefit Fund Assets for Retiree Health

The provision allows assets in excess of 120 percent of current liability to be used to fund retiree health benefits. Further, additional contributions to the defined benefit plan would be required when asset values fan below 120 percent of current liability. The provision applies to both single employer plans and collectively bargained plans.

Trade Provisions

The Volume Purchase Rebate Investing Pension Protection Plan includes a number of trade provisions that increase trade and economic opportunities for American businesses, workers and consumers.

1. Tariff Suspensions

a. Television Tariff Suspension
The provision provides for the suspension of duties on liquid crystal device (LCD) panel assemblies for use in LCD direct view televisions through 2009.
b. Extension of Ceiling Fan Tariff Suspension The provision provides for the continued suspension of duties on ceiling fans through 2009.
c. The provision provides for the continued suspension of duties on certain nuclear steam generators, reactor vessel heads and press urizers through 2010.
   2. Suspension of New Shipper Bonding Privilege

The provision temporarily suspends the ability of importers of subject merchandise from new shippers to choose to post a bond or security in lieu of a cash deposit of estimated duties. The provision also requires the Secretary to report on the effects of this change in law and on problems related to collection of duties.

3. Wool Trust Fund and Wool Fabric Duty Suspension

Present law provides for temporary duty reductions or duty suspensions of certain fabrics made from worsted wool and for payments made under the wool trust fund. The fund consists of three special refund pools for importers of wool fabric, wool yarn, and wool fiber and top, and identifies all persons eligible for the refunds including U.S. manufacturers of these products. The provision extends the current program for an additional two years through 2009.

4. Miscellaneous Trade Provisions

The Volume Purchase Rebate Investing Pension Protection Plan includes provisions taken from House-passed H.R. 4944, the Miscellaneous Trade and Technical Corrections Act of 2006, for which there are Senate companions introduced, which suspend or reduce the tariff rate on certain selected products. The provisions also correct government errors or authorize re-liquidations of duties related to certain products.

5. Vessel Repair Duties

This provision clarifies that the 50 percent advalorem duty on vessel repairs excludes the cost of equipment, repair parts, and materials that are installed on a vessel documented under the laws of the United States and engaged in the foreign or coasting trade, if the installation is done by members of the regular crew of such vessel while the vessel is on the high seas, in foreign waters, or in a foreign port, and does not involve foreign shipyard repairs by foreign labor. The provision is effective on the date of enactment, and it applies to vessel equipment, repair parts, and materials installed on or after Apr. 25, 2001.

6. CAFT A-DR Provisions Regarding Agreement Implementation

The provision extends narrow proclamation authority to the President to implement certain changes to certain apparel rules of origin with respect to countries that have entered into letters of understanding concerning pocketing material with the United States and, subject to certain limitations, with respect to countries, which have not entered into such letters of understanding with the United States. In addition, the provision provides a technical correction with respect to application of a retroactive effective date for certain liquidations and reliquidations of coproduced products. The provision also creates a reporting requirement for the U.S. Trade Representative's Office on the status of negotiations related to other CAFT A-DR textile changes concerning socks and technical corrections.

Other Provisions

1. Technical Corrections Relating to Mine Safety

The provision makes technical corrections to the Mine Improvement and Emergency Response Act of 2006

2. Going-To-The-Sun Road

The provision makes a technical correction to the SAFEJEA-W with respect to the treatment of the Going-TO-The-Sun Road.

3. Certain Hydroelectric Facilities in Alaska

The provision provides an exception to certain tax-exempt bond rules for certain hydroelectric facilities located in Alaska.

4. Permanent Extension and Grant of Regulatory Authority with Respect to Section 529 Qualified Tuition Programs

The provision permanently extends the rules for Section 529 qualified tuition programs. The provision also provides the Secretary with regulatory authority to prevent tax abuse,

### The Volume Purchase Rebate Investing Pension Protection Plan

Detailed Summary of Charitable Provisions

Overview

The Volume Purchase Rebate Investing Pension Protection Plan contains a charitable giving incentives package and a charitable reform package. It is important to note that the Volume Purchase Rebate Investing Pension Protection Plan does not contain controversial Senate charitable reform provisions that have drawn bipartisan concern, such as the mandatory payout requirements applicable to donor advised funds and supporting organizations and the 100 percent excise tax on certain life insurance contracts in which a charitable organization has an interest.

Charitable Giving Incentives

The Volume Purchase Rebate Investing Pension Protection Plan contains a charitable giving incentives package designed to encourage charitable donations.

1. Tax-Free Distributions from IRAs for Charitable Purposes

The provision provides an exclusion from gross income for certain distributions of up to $100,000 from a traditional individual retirement account (IRA) or a Roth IRA, which would otherwise be included in income. To qualify, the charitable distribution must be made to a tax˜exempt organization to which deductible contributions can be made. The provision is effective for two years through 2007.

2. Charitable Deduction for Contributions of Food Inventory

For donations of food inventory, the provision extends for all trades and businesses an enhanced deduction equal to the lesser of (i) the taxpayer's basis plus one-half of the difference between fair market value and basis, and (ii) twice the taxpayer's basis in the contributed inventory. The provision is effective for two years through 2007.

3. Basis Adjustment to Stock of S Corporation Contributing Property

The provision provides that the amount of a shareholder's basis reduction in the stock of an S corporation, by reason of a charitable contribution made by the corporation, will be equal to the shareholder's pro rata share of the adjusted basis of the contributed property. The provision is effective for two years through 2007.

4. Charitable Deduction for Contributions of Book Inventory

The provision extends the current-law provision that adds public schools to the list of eligible donors for the enhanced deduction for contributions of qualified book inventory by C corporations. The provision is effective for two years through 2007.

5. The Tax Treatment of Certain Payments to Controlling Exempt Organizations

Under current law, rent, royalty, annuity, and interest income paid to a tax-exempt organization by a controlled taxable subsidiary is generally treated as unrelated business income, which is taxable to the tax-exempt parent organization. The provision provides that payments received or accrued by certain exempt parents from taxable controlled subsidiaries will not be treated as unrelated business taxable income. Exempt organizations are required to report certain amounts received from controlled organizations. The provision is effective for two years through 2007.

6. Qualified Conservation Contributions

The provision raises the charitable deduction limit from 30 percent of adjusted gross income to 50 percent of adjusted gross income for qualified conservation contributions, provided that such contribution does not prevent the use of the donated land for farming or ranching purposes. The charitable deduction limit is raised to 100 percent of adjusted gross income for eligible farmers and ranchers. The provision allows a taxpayer to carry forward the deduction for 15 years, provided that the taxpayer is a farmer or rancher in the year of the carry forward. The provision is effective for two years through 2007.

7. Excise Tax Exemption for Blood Collector Organizations

The provision provides that certain blood collector organizations are exempt from certain excise taxes with respect to activities related to blood collection.

Charitable Reform

The Volume Purchase Rebate Investing Pension Protection Plan contains a charitable reform package designed to responsibly regulate exempt organizations.

1. Treasury Report on Certain Life Insurance Contracts

Charitable organizations must report to the Secretary certain acquisitions of interests in certain insurance contracts for two years beginning on the date of enactment. The Secretary is required to issue a report within 30 months after the date of enactment examining if acquisitions of applicable insurance contracts is consistent with the tax-exempt purposes of those charitable organizations that acquire such contracts.

2. Fines and Penalties Applicable to Charitable Organizations

The provision doubles the amount of excise taxes applicable to certain activities by charities, social welfare organizations, private foundations and exempt organization managers.

3. Charitable Contributions of Facade Easements

Under the provision, a charitable deduction is allowed with respect to easements concerning buildings located in a registered historic district. The easement must provide that no portion of the exterior of the building may be changed or altered in a manner inconsistent with the historical character of the exterior. The provision also clarifies that the charitable deduction is reduced if a rehabilitation tax credit has been claimed with respect to the donated property.

4. Taxidermy and Substantiation of Exempt Use Property

The provision limits the basis for donated taxidermy property to the cost of preparing, stuffing and mounting an animal. The value of the deduction would be equal to the lesser of basis or fair market value.

5. Recapture of Tax Benefit for Charitable Contributions of Exempt Use Property Not Used for an Exempt Use

The provision provides for the recovery of the tax benefit derived from the contribution of property with respect to which a fair market value deduction was claimed if the property is not used for an exempt purpose of the donor organization.

6. Clothing and Household Items

The provision specifies that no deduction is allowed for charitable contributions of clothing and household item s if such items are not in good used condition or better. In addition, the Secretary may deny a deduction for any item with minimal monetary value.

7. Modification of Record keeping Requirements for Certain Charitable Contributions

The provision requires that in the case of a charitable contribution of money, regardless of the amount, the donor must maintain a cancelled check, bank record or receipt from the donor organization showing the name of the donor organization, the date of the contribution, and the amount of the contribution.

8. Partial Interest in Donated Property

The provision requires that charities receiving a fractional interest in an item of tangible personal property must take complete ownership of the item within 10 years or the death of the donor, whichever is first. In addition, the donor must have (i) taken possession of the item at least once during the 10-year period as long as the donor remains alive, and (ii) used the item for the organization's exempt purpose. Failure to comply with these requirements results in the recapture of all tax benefits plus interest and the imposition of a 10 percent penalty.

9. Appraisal Reform

The provision lowers the thresholds for imposing accuracy-related penalties on a taxpayer who claims a deduction for donated property for which a qualified appraisal is required. The provision also applies for purposes of estate tax appraisals and provides definitions of a qualified appraiser and qualified appraisals.

10. Credit Counseling

The provision imposes certain requirements on tax-exempt organizations that offer credit-counseling services, subject to a four-year transition rule to limit the allowable amount of debt management plan (DMP) income to 50 percent of revenues. In order to stem abusive situations, the provision imposes restrictions on organizations offering credit-counseling services with respect to loans, fees, and solicitation of contributions from consumers receiving counseling.

11. Private Foundation Net Investment Income Excise Tax

The provision amends the definition of gross investment income to include capital gains, notional principal contracts, annuities, and other substantially similar investment income.

12. Convention or Association of Churches

The provision clarifies the definition of a convention or association of churches.

13. Notification Requirement for Exempt Organizations

The provision requires certain exempt organizations to file an annual notice with the IRS containing basic contact and financial information. The requirement applies to organizations that currently do not have an annual filing requirement because their gross receipts are less than $25,000.

14. Encourage IRS Information-Sharing with State Charity Officials

This provision provides that upon written request by an appropriate state official, the Secretary may disclose information regarding organizations for which the IRS has denied or revoked tax˜exempt status, certain other actions the IRS may have taken, and returns filed by tax-exempt organizations.

15. Public Disclosure of Information Relating to Unrelated Business Income Tax Returns

The provision extends the present-law public disclosure requirements applicable to Form 990 to the unrelated business income tax returns of Section 501(c)(3) organizations.

16. Treasury Study on Donor-Advised Funds and Supporting Organizations

The Secretary will undertake a study on the organization and operation of donor-advised funds and of supporting organizations. The study will include an examination of requirements for determining if such organizations are operating in a manner consistent with the purposes or functions constituting the basis for their tax-exempt status.

17. Improved Accountability for Donor-Advised Funds and Supporting Organizations

The provision applies an excess benefits transaction tax on any grant, loan, compensation or other similar payments from a donor-advised fund to a person that with respect to such fund is a donor, donor adviser, or a related person, and from a supporting organization to a substantial contributor or a related person. The provision imposes excess business holdings rules on donor advised funds and Type III supporting organizations. Transition rules apply to the present holdings of donor-advised funds and supporting organizations. Supporting organizations that are functionally integrated with their charity would not be subject to any excess business holdings rules.

I claim:

1. A system for planning, funding and managing pension accounts, pension funds, individual retirement funds or accounts (to include 401k, traditional, spousal or Roth IRA's) while using the provisions of the Pension Protection Act Of 2006 during purchasing merchandise, and while real-time interactively direct ordering or reordering by a plurality of purchasers, who are purchasing individually or purchasing individually, yet in fact group purchasing, and for arranging rebates or group purchase rebates paid into said pension accounts, pension funds, individual retirement accounts, the system comprising:
(a) one or more purchasing cards, said purchasing cards identifying buyers, and financial institutions and one or more card readers;
(b) at least one buyer Purchase Appliance or buyer on-site computer system comprising one or more servers, one or more recording system modules, one or more alarm modules, one or more metering modules, one or more microprocessors, one or more universal barcode ROM microprocessor systems modules, one or more control/relay modules, one or more microprocessor buses, one or more computer/server buses, one or more control/relay buses, one or more power buses, and one or more auxiliary batteries;
(c) one or more purchasing agent ordering sub-systems;
(d) one or more communication means by which said at least one buyer Purchase Appliance or on-site computer communicates with one or more seller Purchase Appliances;
(e) at least one seller Purchase Appliance or seller on-site computer system in communication with said at least one sensor, said seller Purchase Appliance or seller on-site computer system comprising one or more cameras, said seller Purchase Appliance or seller on-site computer further comprising means for receiving signals for the purchase of goods or services, said signals being received from at least one sensor;
(f) at least one Purchase hub computer comprising at least one database module or at least one relational database module or at least one look-up module;
(g) said at least one seller Purchase Appliance or seller on-site computer system being in communication with at least one remote product demonstration sub-system, or one or more seller showrooms, or one or more seller tradeshow booths; and
(h) said at least one remote product demonstration sub-system, seller showroom, or seller tradeshow booths containing or communicating with at least one merchandise display sub-system which allows real-time interactive remote viewing of physical merchandise, enabling at least one buyer to communicate with said at least one remote product demonstration sub-system, or one or more seller showrooms, or one or more seller tradeshow booths via said at least one seller Purchase Appliance or seller on-site computer, to view physical merchandise, enhancing said buyer's view of said physical merchandise by using said at least one seller Purchase Appliance or on-site computer to interactively move said physical merchandise; and
(i) said at least one merchandise display sub-system comprising at least one of a motorized revolving hanger rack or a motorized revolving platform, said physical merchandise being suspended from the motorized hanger rack or being located upon said motorized revolving platform, and said at least one merchandise display sub-system enabling the buyer to move said physical merchandise by remotely controlling said at least one of a motorized revolving hanger rack or a motorized revolving platform;
(j) whereby the one or more purchasing cards identifying buyers are credit, debit, or other funds transfer cards, by which funds are transferred from buyers' credit or debit accounts to sellers' accounts in payment for goods or services bought by buyers, and whereby a portion of said funds transferred from a buyer's credit or debit account when a purchase is made by that buyer are transferred to a second account of said buyer, said second account being an account for the benefit of said buyer in retirement.

2. The system of claim 1, the system being in communication with one or more financial institutions, comprising: one or more credit unions, one or more seller banks, or one or more purchaser account financial institutions.

3. The system of claim 1, wherein the at least one purchasing agent ordering subsystem comprises at least one means for arranging volume purchasing transactions by buyers, at least one Purchase hub computer, at least one means for arranging volume purchasing transactions by agents known as certified purchasing planners, or at least one certified purchasing planner computer.

4. The system of claim 1, wherein at least one Purchase hub computer is a Volume Purchase Rebate Investing Computer and comprises: at least organization module, at least one membership module, at least one broker module, at least one merchant module, at least one meter consumption module for goods and products, at least one monitoring alarm module for services, at least one control module, at least one purchasing module, at least one volume purchasing module, at least one excess inventory purchasing module, at least one excess capacity purchasing module, at least one rebate module, at least one saving account module, and at least one investing account module.

5. The system of claim 1, wherein said at least one buyer can also enhance said buyer's view of said physical merchandise by controlling the position of one or more cameras through which said physical merchandise is viewed.

6. The system of claim 1, wherein the one or more cameras comprised in said seller Purchase Appliance or seller on-site computer comprise at least one of a finger bracket camera, a cap camera, a covert camera, or a camera mounted on a tripod.

7. The system of claim 1, wherein said at least one buyer Purchase Appliance or buyer on-site computer system communicates with said at least one said seller Purchase Appliance which is a seller Volume Purchase Rebate Investing Appliance or seller on-site computer by means of at least one of a direct wire, infrared signal transmission, optical signal transmission, or laser signal transmission.

8. The system of claim 1, wherein said at least one buyer Purchase Appliance or buyer on-site computer system is located in a buyer's home;

9. The system of claim 1, wherein said buyer Purchase Appliance is a buyer Volume Purchase Rebate Investing Appliance; whereby the buyer receives Volume Purchase Rebate Investing information on Volume purchases of merchandise and/or services;

10. The system of claim 1, wherein said second account of said buyer comprises at least one financial investment instrument, and said second account of said buyer comprises at least one IRA account.

11. A system using the provisions of the Pension Protection Act Of 2006 while implementing the individual purchase or volume purchase of merchandise, and for causing rebates to be credited to a pension account, pension fund or retirement account of a buyer, the system comprising:
(a) at least one real-time interactive show-room containing interactive online video and/or audio capturing, processing, or recording means, merchandise displaying means, camera mounting or transversing means, communications, and purchasing facilitation means;
(b) at least one merchandise display case whereon merchandise is placed for real time interactive online viewing of said merchandise;
(c) said at least one merchandise display case further comprising at least one camera, and means for dial-up real-time interactive viewing;
(d) means for lighting said at least one merchandise display case;
(e) means for changing a scene presented to remote viewers of said merchandise;
(f) means for enabling a remote buyer to interactively move said merchandise placed on said display case, enabling said remote buyer to vary or improve said remote buyer's view of said merchandise; and
(g) means for a remote buyer to transfer funds to a seller of said merchandise, in payment for purchase of said merchandise by the remote buyer, or in payment for purchase of other merchandise, or in payment for purchase of services;
(h) wherein a portion of said payment is rebated to an account of said buyer, said account being an account for the benefit of said buyer in retirement.

12. The system of claim 11, wherein said at least one real-time interactive show-room contains a closed circuit television purchasing system or elements thereof, the closed circuit television purchasing system including means for enabling cameras mounted on a track, in a dome, or on a stand, to pan, tilt, or zoom, signals from the cameras being processed or digitally recorded, thereby allowing real-time interactive online viewing of said at least one real-time interactive show-room.

13. The system of claim 11, wherein said at least one merchandise display case comprises track-mounted pan, tilt, or zoom cameras, or lights.

14. The system of claim 11, wherein said at least one real-time interactive show-room further comprises track-mounted pan, tilt, or zoom cameras, glass counters or show cases, system transmission or reception means, or at least one Purchase Appliance for control purposes, or for dial-up real-time interactive viewing purposes and means for lighting said at least one merchandise display case and/or said means for changing a scene presented to remote viewers of said merchandise, comprise one or more of: track lights, multi-colored backlights, a white back-drop, or a rear view projection system and means for enabling a remote buyer to interactively move said merchandise comprises: motorized rotating product hanger racks or motorized rotating product platforms;

15. The system of claim 11, wherein said buyer Purchase Appliance is a buyer Volume Purchase Rebate Investing Appliance; whereby the buyer receives Volume Purchase Rebate Investing information on Volume purchases of merchandise and/or services and said account for the benefit of said buyer in retirement comprises at least one financial investment instrument, and said account for the benefit of said buyer in retirement comprises at least one IRA account.

16. A method for planning, funding and managing pension accounts, pension funds, individual retirement funds or accounts (to include 401k, traditional, spousal or Roth IRA's) while using the provisions of the Pension Protection Act Of 2006 during purchasing merchandise, and while real-time interactively direct ordering or reordering by a plurality of purchasers, who are purchasing individually or purchasing individually, yet in fact group purchasing, and for arranging rebates or group purchase rebates paid into said pension accounts, pension funds, individual retirement accounts, the method comprising:
(a) inputting one or more purchasing cards into at least one card reader;
(b) operating at least one buyer Purchase Appliance or buyer on-site computer comprising one or more servers, one or more recording system modules, one or more alarm modules, one or more metering modules, one or more microprocessors, one or more universal barcode ROM microprocessor systems modules, one or more control relay modules, one or more microprocessor buses, one or more computer/server buses, one or more control/relay buses, one or more power buses, and one or more auxiliary batteries;
(c) operating at least one purchasing agent sub-system;
(d) said at least one buyer Purchase Appliance or on-site computer communicating with one or more seller Purchase Appliances;
(e) operating at least one seller Purchase Appliance or on-site computer system in communication with said at least one sensor, said seller Purchase Appliance or on-site computer comprising one or more cameras, said seller Purchase Appliance or on-site computer receiving from at least one sensor signals for the purchase of goods or services;
(f) viewing physical merchandise remotely and interactively by at least one buyer, said buyer using said at least one sensor to communicate with at least one remote product demonstration module via said at least one Purchase Appliance or on-site computer; and
(g) interactively moving, by at least one buyer, said physical merchandise, the moving of said physical merchandise being accomplished by remotely controlling at least one of a motorized revolving hanger rack or a motorized revolving platform, said physical merchandise being suspended from the motorized hanger rack or being located upon said motorized revolving platform;
(h) ordering said physical merchandise, or other physical merchandise, or services, by at least one buyer;
(i) transferring payment for merchandise or services from a first account of a buyer to an account of the seller of said merchandise or services; and
(j) transferring a portion of said payment to a second account of said buyer, said second account being an account for the benefit of said buyer in retirement.

17. The method of claim 16, further comprising processing of said one or more purchasing cards, wherein said processing comprises:
(a) processing smart cards, debit cards, or other payment cards for payment transactions or rebate transactions or investment transactions at a credit union; or
(b) processing smart cards, debit cards, or other payment cards for payment transactions or rebate transactions or investment transactions at a seller's bank; or
(c) processing smart cards, debit cards, or other payment cards for payment transactions or rebate transactions or investment transactions at any other financial institution.

18. The method of claim 16, wherein operating at least one sensor detects or collects product information.

19. The method of claim 16, wherein to effect purchase transactions, members of said purchasing agent sub-system communicate with at least one buyer Purchase Appliance or buyer on_site computer, or at least one seller Purchase Appliance or seller on_site computer, or at least one Purchase hub computer, or at least one agent known as a certified purchasing planner, with at least one certified purchasing planner computer and further comprising automatically replenishing a stock of goods or products, wherein automatically replenishing a stock of goods or products comprises at least one seller Purchase Appliance or seller on-site computer communicating with said at least one sensor, said at least one seller Purchase Appliance or seller on-site computer receiving signals for the purchase of goods or services, said signals being received from at least one remote ordering subsystem.

20. The method of claim 16, wherein real-time viewing of merchandise is carried out by said at least one seller Purchase Appliance or seller on-site computer communicating with at least one remote product demonstration module, or at least one seller's subsystem, said least one remote product demonstration module or at least one seller's subsystem being contained in at least one seller showroom, or at least one seller tradeshow booth and said at least one shopper also enhancing said at least one shopper's view of said physical merchandise by controlling the position of one or more cameras through which said physical merchandise is viewed.

21. The method of claim 16, wherein interactive viewing of merchandise comprises a shopper viewing merchandise images obtained by at least one of a finger bracket camera, a cap camera, a covert camera, or a camera mounted on a tripod, said camera of whichever type being in physical proximity to the physical merchandise being viewed.

22. The method of claim 16, wherein said at least one sensor communicates with said at least one said seller Purchase Appliance or seller on-site computer by means of at least one of a direct wire, infrared signal transmission, optical signal transmission, or laser signal transmission and said at least one sensor is located or operated in a buyer's home and further comprising remotely operating a closed circuit television purchasing system including operating enabled cameras mounted on a track, in a dome, or on a stand, to pan, tilt; or zoom, signals from the cameras being processed or digitally recorded, thereby allowing real-time interactive online viewing of at least one real-time interactive show-room.

23. The method of claim 16, wherein said buyer Purchase Appliance is a is a buyer Volume Purchase Rebate Investing Appliance; whereby the method further comprising the buyer receiving Volume Purchase Rebate Investing information on Volume purchases of merchandise and/or services and said second account of said buyer comprises at least one financial investment instrument, to include a Roth IRA and said second account of said buyer comprises at least one IRA account
